(19) United States
(12) Patent Application Publication
(10) Pub. No.: US 2013/0182895 A1
(43) Pub. Date: Jul. 18, 2013

(54) Spectral Domain Optical Coherence Tomography Analysis and Data Mining Systems and Related Methods and Computer Program Products

(71) Applicant: Bioptigen, Inc., Morrisville, NC (US)

(72) Inventors: Igor Touzov, Cary, NC (US); Bradley A. Bower, Hillsborough, NC (US); Eric L. Buckland, Hickory, NC (US)

(73) Assignee: Bioptigen, Inc., Morrisville, NC (US)

(21) Appl. No.: 13/664,785

(22) Filed: Oct. 31, 2012

Related U.S. Application Data
(60) Provisional application No. 61/576,206, filed on Dec. 15, 2011.

(51) Int. Cl. G06T 11/00; G06T 7/00

(52) U.S. Cl. CPC G06T 11/003; G06T 7/0051
USPC 382/103

(57) ABSTRACT

Methods for analyzing images acquired using an image acquisition system include receiving a plurality of images from at least one image acquisition system; selecting at least a portion of a set of images for analysis using at least one attribute of image metadata; selecting at least one method for deriving quantitative information from the at least a portion of the set of images; processing the selected at least a portion of the set of images with the selected at least one method for deriving quantitative information to generate an intermediate set of quantitative data associated with the at least a portion of the set of images; and storing the intermediate set of quantitative data and the metadata in a reference database, the reference database including intermediate sets of quantitative data and associated metadata for images associated with a plurality of subjects.

### CLAIM OF PRIORITY

The present application claims priority from U.S. Provisional Application No. 61/576,206 (Attorney Docket No. 9526-41PR), filed Dec. 15, 2012, the disclosure of which is hereby incorporated herein by reference as if set forth in its entirety.

### FIELD

The present inventive concept relates to imaging and, more particularly, to systems, methods and computer program products for analysis and data mining of image data.

### BACKGROUND

Data mining is a technique by which patterns may be identified in seemingly unstructured data. This data can be any type of data, for example, data mining is often used in the medical field so that information associated with a single patient, or group of patients, may be located in existing databases of unstructured data. Data mining techniques are discussed in, for example, U.S. Pat. Nos. 6,112,194; 7,539,927; 7,594,889; 7,627,620; and 7,752,057, the disclosures of which are hereby incorporated herein by reference as if set forth in their entirety.

As discussed above, one area where there is an ever increasing need to identify patterns in unstructured data is in the medical field. Medical data exists in various forms, for example, patient histories and demographic data, clinical and lab results, images (computed tomography (CT) scans, ultrasounds, magnetic resonance imaging (MRI), positron emission tomography (PET) scans and the like), billing information and insurance codes. Just imaging systems and assays alone produce a tremendous amount of relatively unstructured data. Many conventional data mining techniques are available to locate patterns in this vast amount of unstructured data so that more accurate diagnoses may be provided and more subtle markers of disease and disease progression may be identified.

Optical coherence tomography in general, and the broad class of Fourier domain optical coherence tomography (FDOCT) imaging systems specifically, are now routinely applied to soft tissue clinical imaging problems, notably in ophthalmology and cardiology, and increasingly oncology. Data analysis and mining techniques may enable new methods of assisted diagnosis and telemedicine.

### SUMMARY

Some embodiments of the present inventive concept provide methods for analyzing images acquired using an image acquisition system, the method comprising receiving a plurality of images from at least one image acquisition system; selecting at least a portion of a set of images for analysis using at least one attribute of image metadata; selecting at least one method for deriving quantitative information from the at least a portion of the set of images; processing the selected at least a portion of the set of images with the selected at least one method for deriving quantitative information to generate an intermediate set of quantitative data associated with the at least a portion of the set of images; and storing the intermediate set of quantitative data and the metadata in a reference database, the reference database including intermediate sets of quantitative data and associated metadata for images associated with a plurality of subjects.

In further embodiments, receiving further comprises receiving the plurality of images in one or more blobs of data, each blob having associated metadata; and reconstructing the plurality of images based on the received one or more blobs and the associated metadata. The received blobs of data may be received in one of the frequency domain and the spatial domain.

In still further embodiments, the one or more blobs of data may include a plurality of blobs of data in a stream of data. The method may further include creating a branch in the stream of data to provide a first stream of raw data and a second stream of processed data,

In some embodiments, the at least one image acquisition system may be at least one Optical Coherence Tomography (OCT) imaging system. The at least one OCT imaging system may include at least one portable Fourier domain Optical Coherence Tomography (FDOCT) imaging System.

In further embodiments, the method may further include receiving a first multi-dimensional query at the reference database related to a subject of interest; generating results satisfying the first multi-dimensional query; updating the reference database based on the results satisfying the first multi-dimensional query; refining the first multi-dimensional query based on the generated results to provide a second multi-dimensional query; and receiving the second multi-dimensional query at the updated reference database related to the subject of interest.

In still further embodiments, the second multi-dimensional query may be configured to search only the results satisfying the first multi-dimensional query.

In some embodiments, the method may further include associating the derived quantitative information with the at least a portion of the set of images via a data structure; selecting at least one method for aggregating at least a portion of a set of derived quantitative information into a reduced set of results; and generating at least one report to represent the reduced set of results for one of an individual image and the set of images as a pool.

In further embodiments selecting at least a portion of a set of images for analysis is preceded by determining specific analysis packages that are licensed on a local computer; and dynamically populating a user interface associated with the image analysis system with controls specific to the licenses for the local computer.

In still further embodiments, the image metadata may include one or more of: a patient demographic data; an individual responsible for drawing inferences from the data; an individual responsible for acquiring the images; a window of time for acquiring the images; a position in a sequence of events along which images may be acquired; a descriptor of instruments that may be used to acquire the image data; a descriptor of instrument settings used to acquire an image; a descriptor of image quality associated with an image; quantitative results derived from the image; an inference applied to the image; and an annotation associated with an image.

In some embodiments, the method further includes one of a method involving user intervention with a representation of the image displayed on graphical display; a method that is fully automated through computer algorithms without user intervention; and a method including a combination of user intervention and computer algorithms.

Further embodiments of the present inventive concept provide methods of transmitting image data acquired using a portable optical coherence tomography (OCT) image acquisition device include continuously transmitting OCT image data during data acquisition by the portable image acquisition system, the data being transmitted as one or more blobs of data, wherein each blob of data has associated metadata; and wherein the metadata includes information for reconstructing the OCT image data upon receipt at a specified destination.

In still further embodiments, one or more blobs may each include kilobytes of data.

In some embodiments, continuously transmitting OCT image data may include transmitting the OCT image data in the frequency domain. In certain embodiments, a Fourier transform process may be performed on the blobs before the image data is reconstructed.

In further embodiments, continuously transmitting OCT image data may include transmitting the OCT image data in the spatial domain.

Still further embodiments provide systems for analyzing images including an image acquisition system configured to acquire a plurality of images; and an image analysis module configured to receive a plurality of images from at least one image acquisition system; select at least a portion of a set of images for analysis using at least one attribute of image metadata; select at least one method for deriving quantitative information from the at least a portion of the set of images; process the selected at least a portion of the set of images with the selected at least one method for deriving quantitative information to generate an intermediate set of quantitative data associated with the at least a portion of the set of images; and store the intermediate set of quantitative data and the metadata in a reference database, the reference database including intermediate sets of quantitative data and associated metadata for images associated with a plurality of subjects.

In some embodiments, the image analysis system is further configured to receive the plurality of images in one or more blobs of data, each blob having associated metadata; and reconstruct the plurality of images based on the received one or more blobs and the associated metadata. The received blobs of data may be received in one of the frequency domain and the spatial domain.

In further embodiments, the one or more blobs of data may include a plurality of blobs of data in a stream of data. The method further includes creating a branch in the stream of data to provide a first stream of raw data and a second stream of processed data.

In still further embodiments, the at least one image acquisition system may include at least one Optical Coherence Tomography (OCT) imaging system. In certain embodiments, the at least one OCT imaging system may include at least one portable Fourier domain Optical Coherence Tomography (FDOCT) imaging System.

In some embodiments, the image analysis module may be further configured to receive a first multi-dimensional query at the reference database related to a subject of interest; generate results satisfying the first multi-dimensional query; update the reference database based on the results satisfying the first multi-dimensional query; refine the first multi-dimensional query based on the generated results to provide a second multi-dimensional query; and receive the second multi-dimensional query at the updated reference database related to the subject of interest.

In further embodiments, the second multi-dimensional query may be configured to search only the results satisfying the first multi-dimensional query.

Still further embodiments provide computer program products for analyzing images acquired using an image acquisition system include a non-transitory computer-readable storage medium having computer-readable program code embodied in the medium. The computer-readable program code includes computer readable program code configured to receive a plurality of images from at least one image acquisition system; computer readable program code configured to select at least a portion of a set of images for analysis using at least one attribute of image metadata; computer readable program code configured to select at least one method for deriving quantitative information from the at least a portion of the set of images; computer readable program code configured to process the selected at least a portion of the set of images with the selected at least one method for deriving quantitative information to generate an intermediate set of quantitative data associated with the at least a portion of the set of images; and computer readable program code configured to store the intermediate set of quantitative data and the metadata in a reference database, the reference database including intermediate sets of quantitative data and associated metadata for images associated with a plurality of subjects.

Some embodiments provide computer program products for transmitting image data acquired using a portable optical coherence tomography (OCT) image acquisition device. The computer program product includes a non-transitory computer-readable storage medium having computer-readable program code embodied in the medium. The computer-readable program code includes computer readable program code configured to continuously transmit OCT image data during data acquisition by the portable image acquisition system, the data being transmitted as one or more blobs of data, wherein each blob of data has associated metadata; and wherein the metadata includes information for reconstructing the OCT image data upon receipt at a specified destination.

### BRIEF DESCRIPTION OF THE DRAWINGS

FIG. 1 is a block diagram of a data processing system suitable for use in some embodiments of the present inventive concept.

FIG. 2 is a more detailed block diagram of a system according to some embodiments of the present inventive concept.

FIG. 3 is a block diagram illustrating a system including an Image Analysis System in accordance with some embodiments of the present inventive concept.

FIGS. 4A through 4E are images illustrating portable image analysis systems (A) in use in pediatric (B) and perioperative (C) imaging of retinblastoma (D) and ocular trauma associated with Shaken Baby Syndrome (E).

FIG. 5 is a block diagram illustrating systems for providing analysis and reporting services to imaging systems in accordance with some embodiments of the present inventive concept.

FIG. 6 is a flowchart illustrating operations of the system of FIG. 5 in accordance with some embodiments of the present inventive concept.

FIGS. 7A-7C are flow diagrams illustrating a current image acquisition and data persistence model (A) a BPN stream format (B) which enables a stream-based data persistence model (C) in accordance with some embodiments of the present inventive concept.

FIG. 8 illustrates flow diagrams in accordance with some embodiments of the present inventive concept that specifically illustrate branching streams to persist raw data after image processing or transformation.

FIG. 9 is a flowchart illustrating operations of acquiring images in accordance with some embodiments of the present inventive concept.

FIG. 10 is a flowchart illustrating operations of acquiring images in the frequency domain in accordance with some embodiments of the present inventive concept.

FIG. 11 is a flowchart illustrating operations of acquiring images in the spectral domain in accordance with some embodiments of the present inventive concept.

FIG. 12 is a block diagram of systems in accordance with some embodiments of the present inventive concept.

FIGS. 13A-13C illustrate various screens of a graphical user interface illustrating data selection in accordance with some embodiments of the present inventive concept.

FIG. 14 is a diagram illustrating a software development kit in accordance with some embodiments of the present inventive concept.

FIG. 15 is an image segmentation flowchart for automated mouse retinal boundary segmentation in accordance with some embodiments of the present inventive concept.

FIGS. 16A and B are images/data provided by the system in accordance with some embodiments of the present inventive concept.

FIGS. 17A through 17E is a diagram illustrating an exemplary report produced using an imaging analysis system in accordance with some embodiments of the present inventive concept.

FIGS. 18A and 18B are diagrams illustrating early results of human retina segmentation in accordance with some embodiments of the present inventive concept.

FIG. 19 is a diagram illustrating early segmentation results on human cornea data showing segmentation of the anterior epithelial (upper curved line) and posterior endothelial (lower curved line) layers in accordance with some embodiments of the present inventive concept.

FIGS. 20A through 20C are scans of images of cornea dystrophies and treatment outcomes obtained using systems in accordance with embodiments of the present inventive concept.

FIGS. 21A and 21B are scans of images of retina trauma and wound repair obtained using systems in accordance with some embodiments of the inventive concept

FIG. 22 is a block diagram of systems for real-time streaming of retina image data for remote processing and decision support in accordance with some embodiments of the present inventive concept.

FIG. 23 is a block diagram illustrating a system in accordance with some embodiments of the present inventive concept including various remote locations.

FIG. 24 is a flowchart illustrating operations in accordance with various embodiments of the present inventive concept.

### DETAILED DESCRIPTION

The present inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and the are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein,

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

As discussed above, data mining techniques are being developed to provide more accurate diagnosis of disease. Data mining techniques are discussed in commonly assigned, co-pending patent application Ser. No. 13/459,866 entitle IMAGE ANALYSIS SYSTEM AND RELATED METHODS AND COMPUTER PROGRAM PRODUCTS, filed on Apr. 30, 2012, the contents of which are hereby incorporated herein by referenced as is set forth in their entirety. Some embodiments of the present inventive concept provide systems for management, processing and analysis of image data that may be acquired in a remote environment, for example, a rural community or a military battlefield. As will be discussed further herein, embodiments of the present inventive concept provide methods for streaming data from instruments to remote servers, automated and expert-mediated image analysis and diagnostics, and a powerful data mining and statistical analysis engine for clinical decision making and case studies. Thus, embodiments of the present inventive concept may open new avenues in patient care, for example, in battlefield ocular healthcare, and may integrate in to existing telemedicine and Electronic Health Records (EHR) solutions for clinical case management and research.

As used herein, “telemedicine” refers to the use of telecommunication and/or information technologies in order to provide clinical health care when a patient is remote from the medical provider, for example, in a rural community or a military battlefield. Telemedicine may reduce, or possibly eliminate, distance barriers and may improve access to medical services that would often not be consistently available in distant rural communities, on the military battlefield and the like. Telemedicine may also be used to save lives in critical care and emergency situations. As will be discussed herein, the systems, methods and computer program products discussed herein in accordance with various embodiments of the inventive concept may be used to improve the effectiveness of telemedicine and general clinical case management and research.

Although some embodiments of the present inventive concept will be discussed herein with respect to Optical Coherence Tomography (OCT), it will be understood that with respect to some embodiments other imaging techniques may be used without departing from the scope of the present inventive concept. For example, the images used in the methods, systems and computer program products discussed herein may be computed tomography (CT), ultrasound, magnetic resonance imaging (MRI), positron emission tomography (PET) images or any other type of image that may be used in combination with one or more of the embodiments discussed herein. Furthermore, as used herein, the term Spectral Domain Optical Coherence Tomography, or SDOCT, will be used interchangeably with Fourier Domain Optical Coherence Tomography, or FDOCT, to refer to OCT systems that operate on the basis of spectral, or frequency, domain detection systems with the application of mathematical transforms to generate spatial domain images as are known commonly in the art.

Furthermore, although many of the examples discussed herein refer to the sample being an eye, specifically, the retina, cornea, anterior segment and lens of the eye, embodiments of the present inventive concept are not limited to this type of sample. Any type of sample that may be used in conjunction with embodiments discussed herein may be used without departing from the scope of the present inventive concept.

Finally, although particular uses of embodiments of the present inventive concept may be discussed with respect to a military scenario, embodiments of the present inventive concept are not limited to this configuration. For example, embodiments of the present inventive concept may be used in combination with any remotely located patients as well as in general clinical and research environments without departing from the scope of the present inventive concept.

As will be discussed in detail herein, some embodiments of the present inventive concept may enable high throughput analysis of large datasets for both prospective and retrospective studies. Thus, embodiments of the present inventive concept may advance a researcher's ability to quantify, validate, and publish results more rapidly and less laboriously than is currently possible with conventional methods of managing image data, for example, OCT imaging data. Such methods, systems and computer program products may open new avenues for biological exploration, monitoring of disease progression, and development of therapeutic interventions.

Embodiments of the present inventive concept recognize that the intermediate data collected during image processing and analysis may provide critical data for use in biological exploration, monitoring of disease progression, and development of therapeutic interventions. However, this intermediate data is usually not accessible to the public and may be discarded when the patient file has been updated. For example, in the field of ophthalmology, commercial clinical systems tend to have embedded segmentation algorithms to extract three boundary layers required to measure the two thicknesses, which are the internal limiting membrane (ILM), the Nerve Fiber Layer-Ganglion Cell Complex (NFL-GCC) and the retinal pigment epithelium (RPE). The numerical results are typically plotted on common graphs, and in some cases computed for sectors of a common diagnostic grid. Occasionally statistics are aggregated along specific criteria to form a normative database. As discussed above, such databases are typically proprietary to the equipment manufacturer, and the underlying data has not been available for further exploration or exploitation. More commonly, the data only persists long enough to generate a report for a patient file, though an image of the result may be uploaded to an image server for congruity with electronic medical records management.

Accordingly, some embodiments of the present inventive concept provide methods systems and computer program products that store this intermediate data, for example, processed image data and metadata, in a searchable database. Thus, this intermediate data may be collected and stored and, then, processed, analyzed, reported and reused for medical imaging in research and clinical settings.

Optical Coherence Tomography (OCT) is a high-resolution imaging modality that is ubiquitous for ophthalmic imaging, but deployment to forward or main operating base hospitals has not been practical due to a lack of portability and processing capabilities that support field medicine or existing telehealth applications. Bioptigen has created a robust, mobile spectral domain OCT (SDOCT) ophthalmic imaging system, Bioptigen ENVISU. Embodiments of the present inventive concept target the data management and processing infrastructure and algorithms necessary to support remote care, for example, ocular care of the military community within the context of telehealth and EHR frameworks, through: streaming image data to clinical experts and to expert systems; extracting quantitative information from images; and identifying clinical patterns from statistical analysis of quantitative information. Thus, some embodiments of the present inventive concept may extend the diagnostic capability of SDOCT to remote patients, for example, patients in the defense community, and may improve triage, diagnosis and treatment of these remote patients/subjects.

Telemedicine programs cover a broad range of technologies that are used for diagnosis or patient monitoring across large distances, bringing point of care to remote locations not previously serviceable by traditional healthcare. Existing telehealth applications provide screening or review of patient data by an expert observer. Telemedicine programs may be useful in both military and civil applications in which patient access to specialized care is limited or prescreening is beneficial.

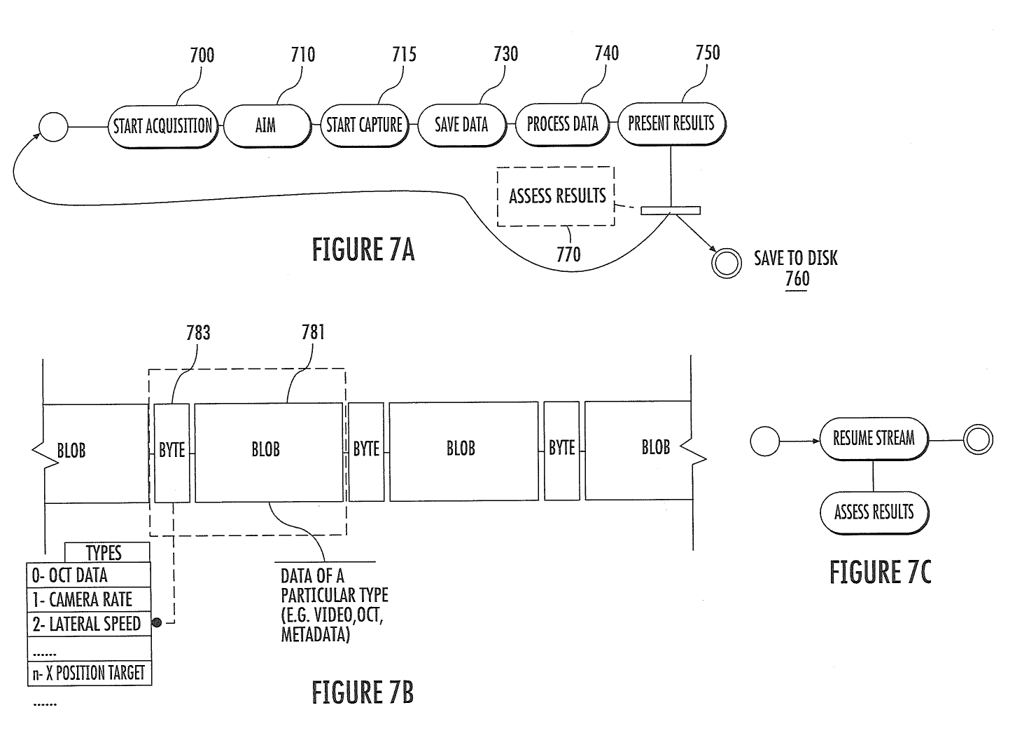

Early successes with store-forward telemedicine in military operations have lead to more complex telemedicine implementations in the field. The store-forward model involves acquiring data to a local machine or server, forwarding to a specialist for review and recommendation, and acting on the recommendation by the point of care physician, discussed below with respect to FIG. 7A.

Existing telehealth programs involve transmission of single or a collection of images with a summary of the patient's condition by the point of care physician, in part due to the limited nature of the technology available to the point of care physician. Portable ultrasound systems are in development for forward deployment to for imaging in the field. Traditional ultrasound systems provide depth and lateral resolution on the order of 100 microns or more, with high frequency ultrasound, or ultrasound biomicroscopy (UBM) providing resolution on the order of 10's of microns. Optical Coherence Tomography (OCT) provides axial and lateral resolution on the order of 3.0 microns and 10 microns, respectively, in the human retina, enabling imaging of ocular microstructure not possible with ultrasound.

Patients present in the field with open and closed globe injuries to the posterior segment and cornea, both of which would benefit from diagnosis or treatment guided by OCT imaging. Advanced ophthalmic imaging technologies could have an immediate impact in prescreening for injury or disease with the highest odds ratio for poor Best Corrected Visual Acuity outcomes and would enable imaging the early mechanisms of injury or disease formation.

Telehealth screening and triage programs require expert reader intervention, and the large amounts of data moving through reading centers can be prohibitive to adoption of telehealth programs. Adoption of data mining techniques to extract maximum information content from the data acquired remotely in accordance with embodiments discussed herein could enhance the potential of existing telehealth programs.

Application of analysis and data mining tools to medical image and demographic data may provide insights into patient management and quality of care and could be used for prescreening or evaluation of existing data.

Current image processing tools for quantifying pathophysiology lag instrumentation development. In contrast to radiological environments, there are no tool sets for analyzing images remote from FDOCT instruments. The high computational complexity makes local analytics impractical for mobile systems. Embodiments of the present inventive concept discussed herein reduce, or possibly resolve, the complexity by uploading analytical functions to dedicated computer clusters accessible remotely or through the cloud, suitable for telemedicine and collaborative research. Embodiments of the present inventive concept provide image processing algorithms in a cloud-based computational and data mining system, couple clinical and research images to rich patient metadata and post-processing methods, maximize diagnostic utility of FDOCT data to address current problems of lack of advanced ocular imaging systems suitable to telemedicine and remote diagnostics of clinical disease and traumatic injury, and compatible with portable field deployable ocular imaging systems.

FDOCT is an established imaging standard for clinical exam of ambulatory patients, with diagnostic information limited to retinal thickness and nerve fiber thickness measurements on a limited number of highly averaged cross sections of depth resolved image data. Thus, systems for field deployment and analytical tools for assessing pathophysiology relevant to the military environment are both lacking. Embodiments of the present inventive concept recognize the need for portability, and have demonstrated the robustness and effectiveness of a first mobile FDOCT system with handheld imaging functionality suitable for perioperative use. Embodiments of the present inventive concept recognize that it is advantageous to process high density volumes rather than a few averaged slices; that statistical analysis of automatically processed images will yield more accurate results; that algorithms can be developed to address traumatic injury; and that the computation cost of remote image processing and data mining will be advantageous to telemedicine and to collaborative research relevant to military healthcare.

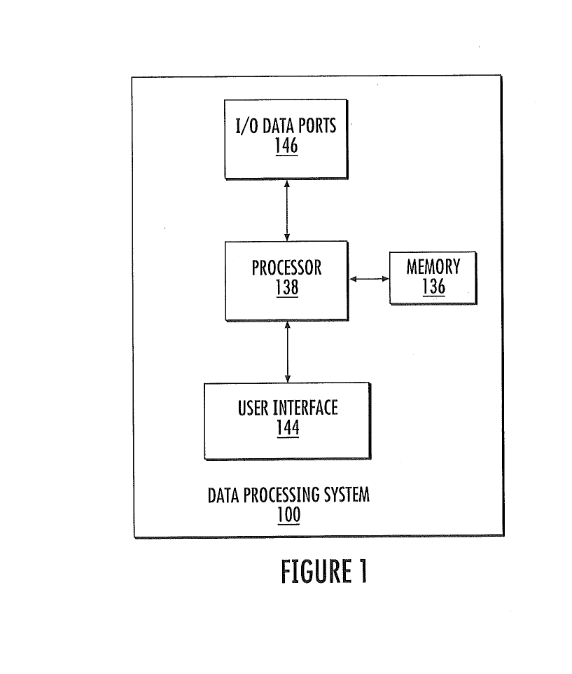

Accordingly, some embodiments of the present inventive concept provide an automated analysis and data mining environment for FDOCT images of the eye, which will include a server based system that will receive high resolution FDOCT images with associated patient metadata. The images are subject to automated analysis to extract structural and functional information from the images without user intervention. Systems in accordance with embodiments discussed herein accommodate batch processing with data sets selected from a “hypercube” query system, allowing the researcher to aggregate collections of data along any dimension of available metadata, thus, facilitating processing. For example, all images from one exam, one patient across multiple exams, all patients with a particular demographic or medical similarity, or all patients subject to a specific treatment. Once processed, the resultant analytics may be stored in a database accessible to other clinicians, allowing subsequent queries without rerunning the analysis methods as will be discussed further herein with respect to FIGS. 1 through 24.

Referring first to FIG. 1, a data processing system 100 in accordance with some embodiments will be discussed. The data processing system 100 may be used to analyze image data acquired by an image acquisition system in accordance with some embodiments of the present inventive concept. As illustrated in FIG. 1, the data processing system 100 may include a user interface 100, including, for example, input device(s) such as a man machine interface (MMI) including, but not limited to a keyboard or keypad and a touch screen; a display; a speaker and/or microphone; and a memory 136 that communicate with a processor 138. The data processing system 100 may further include I/O data port(s) 146 that also communicates with the processor 138. The I/O data ports 146 can be used to transfer information between the data processing system 100 and another computer system or a network, such as an Internet server, using, for example, an Internet Protocol (IP) connection. These components may be conventional components such as those used in many conventional data processing systems, which may be configured to operate as described herein.

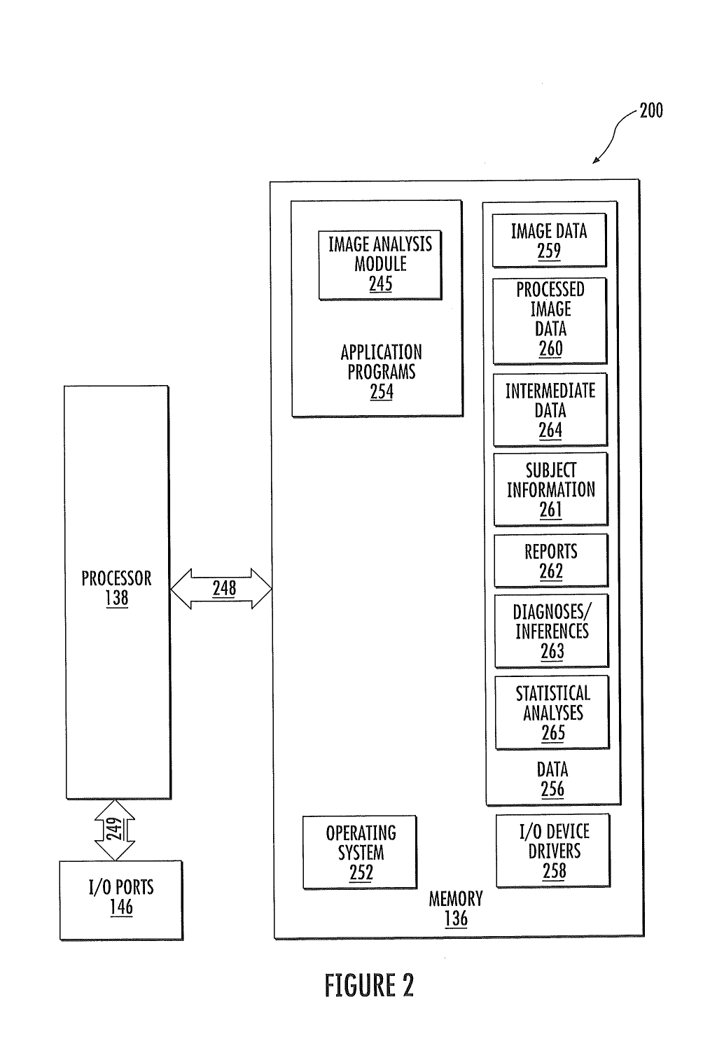

Referring now to FIG. 2, a more detailed block diagram of the data processing system 100 for implementing systems, methods, and computer program products in accordance with some embodiments of the present inventive concept will now be discussed. It will be understood that the application programs and data discussed with respect to FIG. 2 below may be present in, for example, an image analysis system in accordance with some embodiments without departing from the scope of embodiments discussed herein.

As illustrated in FIG. 2, the processor 138 communicates with the memory 136 via an address/data bus 248 and with the I/O ports 146 via an address/data bus 249. The processor 138 can be any commercially available or custom enterprise, application, personal, pervasive arid/or embedded microprocessor, microcontroller, digital signal processor or the like. The memory 136 may include any memory device containing the software and data used to implement the functionality of the data processing system 100. The memory 136 can include, but is not limited to, the following types of devices: ROM, PROM, EPROM, EEPROM, flash memory, SRAM, and DRAM.

As further illustrated in FIG. 2, the memory 136 may include several categories of software and data used in the system 268: an operating system 252; application programs 254; input/output (I/O) device drivers 258; and data 256. As will be appreciated by those of skill in the art, the operating system 252 may be any operating system suitable for use with a data processing system, such as OS/2, AIX or zOS from International Business Machines Corporation, Armonk, N.Y., Windows95, Windows98, Windows2000 or WindowsXP, Windows Vista, Windows? or Windows CE from Microsoft Corporation, Redmond, Wash., Palm OS, Symbian OS, Cisco IOS, VxWorks, Unix or Linux, or Mac. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the system and may include at least one application that supports operations according to embodiments. Finally, as illustrated, the data 256 may include raw image data 259, processed image data 260, subject information 261, reports 262, reduced, or intermediate, image data 264 derived from processed image data, statistical analyses 265 derived from processed image data and reduced image data, and diagnoses/inferences 263, which may represent the static and dynamic data used by the application programs 254, the operating system 252, the I/O device drivers 258, and other software programs that may reside in the memory 136.

In particular, the image data 259 may include images acquired using an image acquisition system, for example, an OCT system. As discussed above, although some embodiments of the present inventive concept will be discussed herein with respect to Optical Coherence Tomography (OCT) imaging systems, it will be understood that other imaging systems may be used without departing from the scope of the present inventive concept. For example, the images used in the methods, systems and computer program products discussed herein may be acquired using computed tomography (CT) systems, ultrasound systems, magnetic resonance imaging (MRI) systems, positron emission tomography (PET) systems or any other type of imaging system that may be used in combination with one or more of the embodiments discussed herein.

Furthermore, the image data 259 may include acquired images from more than one instrument, and more than one subject or patient. As used herein, “subject” refers to the person or thing being imaged. It will be understood that although embodiments of the present inventive concept are discussed herein with respect to imaging specific portions of an eye of a subject, embodiments of the present inventive concept are not limited to this configuration. The subject can be any subject, including a research animal, a veterinary subject, cadaver sample or human subject and any portion of this subject may be imaged without departing from the scope of the present inventive concept.

Furthermore, although many of the examples discussed herein refer to the sample being an eye, specifically, the retina, cornea, anterior segment and lens of the eye, embodiments of the present inventive concept are not limited to this type of sample. Any type of sample that may be used in conjunction with embodiments discussed herein may be used without departing from the scope of the present inventive concept.

As will be discussed further herein below, using image data 259 associated with more than one subject in accordance with various embodiments of the present inventive concept may provided improved medical data, which may lead to more accurate and swift diagnoses of illnesses and the like.

As discussed above, the intermediate data 264 may include abstractions of the data (image), metadata and/or any type of data calculated/obtained before the final processed image is provided. As discussed above, storing the intermediate date 264 and allowing this data to be queried in accordance with various embodiments discussed herein may lead to more accurate and swift diagnoses of illnesses and the like.

The processed image data 260 may include the acquired image data 259 after having been processed using various image analysis techniques in accordance with embodiments discussed herein. Again, it will be understood that the processed image data 260 can include processed image data associated with more than one subject. In fact, the more subjects the analysis module in accordance with embodiments discussed herein has access to, the more accurate and refined the results may be.

The subject information data or metadata 261 may include, for example, the subject's name, age, species, gender, ethnicity, state of health, and other demographics. This subject information data 261 may also include information related to more than one subject, similar to the image data 259 and the processed image data 260 discussed above. It will be understood that this data may be combined and stored with the intermediate date 264 or stored separately as shown in FIG. 2 without departing from the scope of the present inventive concept.

As used herein, “image metadata” may include one or more of: a patient demographic data; an individual responsible for drawing inferences from the data; an individual responsible for acquiring the images; a window of time for acquiring the images; a position in a sequence of events along which images may be acquired; a descriptor of instruments that may be used to acquire the image data; a descriptor of instrument settings used to acquire an image; a descriptor of image quality associated with an image; quantitative results derived from the image; an inference applied to the image; and an annotation associated with an image.

As will be discussed further below, the output of the image analysis system in accordance with some embodiments may be one of various types of reports 262 as well as various diagnoses/inferences 263 and statistical analyses 265. These reports/diagnoses/inferences may be printed out, stored or provided to a third party application for further processing without departing from the scope of the present inventive concept. Furthermore, the output of the image analysis system may be reentered into the system to provide a more detailed output as will be discussed further below.

As will be appreciated by those of skill in the art, although the data 256 in FIG. 2 is shown as including image data 259, processed image data 260, subject information data/metadata 261, reports 262, Intermediate data 264, statistical analyses 265 and diagnoses/inferences 263, embodiments of the present inventive concept are not limited to this configuration. For example, one or more of these data files may be combined to produce fewer over all files or one or more data files may be split into two or more data files to produce more over all files. Furthermore, completely new data files consistent with embodiments of the present inventive concept may be included in the data 256 without departing from the scope of the present inventive concept.

Referring again to FIG. 2, according to some embodiments, the application programs 254 include an image analysis module 245. While the present inventive concept is illustrated with reference to the image analysis module 245, as will be appreciated by those of skill in the art, other configurations fall within the scope of embodiments discussed herein. For example, rather than being an application program 254, these circuits or modules may also be incorporated into the operating system 252 or other such logical division of the system. Furthermore, while the image analysis module 245 is illustrated in a single system, as will be appreciated by those of skill in the art, such functionality may be distributed across one or more systems. Thus, the embodiments discussed herein should not be construed as limited to the configuration illustrated in FIG. 2, but may be provided by other arrangements and/or divisions of functions between data processing systems. For example, although FIG. 2 is illustrated as having only a single module, this module may be split into two or more circuits/modules without departing from the scope of embodiments discussed herein.

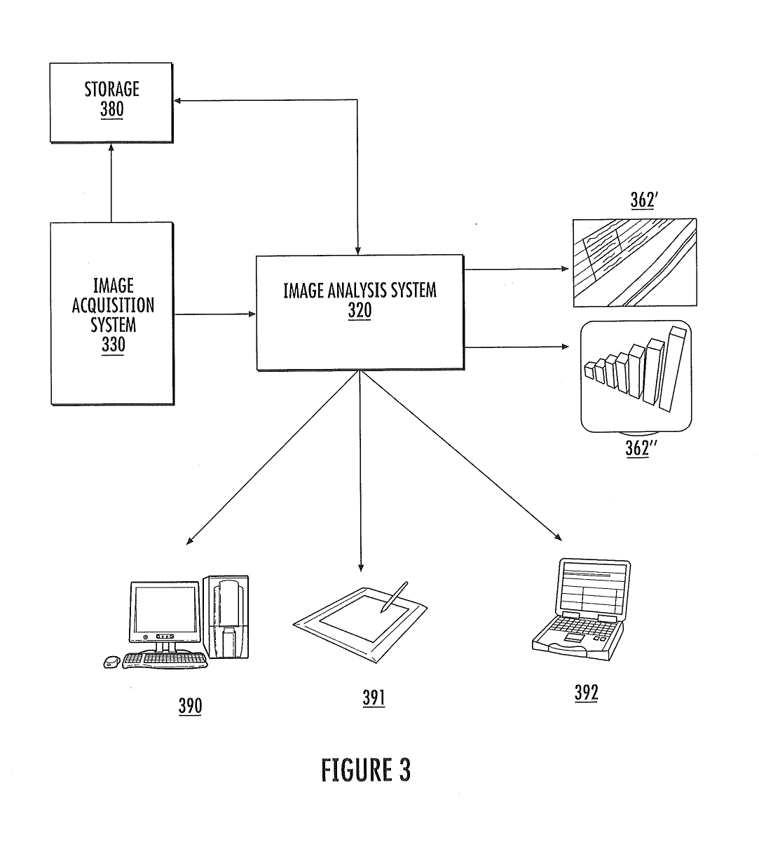

The image analysis module 245 is configured to process received image data in accordance with embodiments discussed herein. FIG. 3 is a block diagram illustrating a system including an image analysis system 320 in accordance with some embodiments of the present inventive concept. The data processing system and the image analysis module 245 discussed with respect to FIGS. 1 and 2 can be included in the image analysis system 320 of FIG. 3.

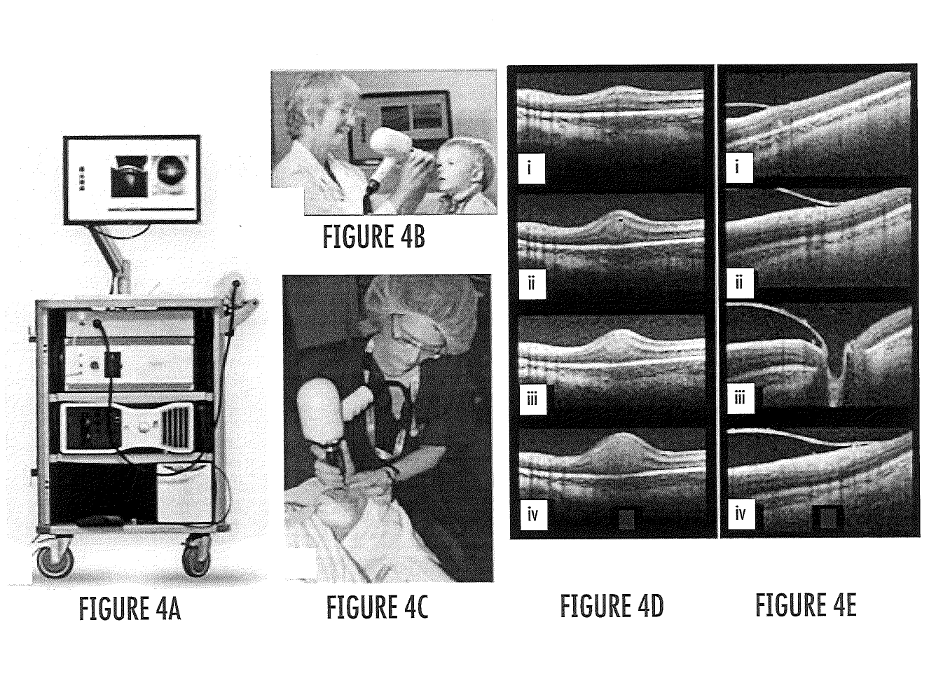

Referring now to FIG. 3, a system in accordance with some embodiments may include an image acquisition system 330, at least one external storage device 380, an image analysis system 320 in accordance with embodiments discussed herein, one or more third party systems 390, 391 and 392 and outputs of the system 362′ and 362″ (reports). As discussed above, the image acquisition system 330 may be an OCT system or any other type of imaging system capable of providing images that can be used in accordance with embodiments discussed herein. In some embodiments, the image acquisition system 330 may be a portable image acquisition system, for example, Bioptigen ENVISU mobile SDOCT system illustrated in FIGS. 4A through 4E. In particular, FIGS. 4A-4E illustrate Bioptigen ENVISU mobile SDOCT system (A) in use in pediatric (B) and perioperative (C) imaging of retinoblastoma (D) and ocular trauma associated with Shaken Baby Syndrome (E).

The portable acquisition system illustrated in FIGS. 4A-4E developed by Bioptigen is the first mobile, handheld SDOCT imaging system with rapid, real-time high density image capture and display suitable for non-ambulatory patients and extra-clinical deployments. The Bioptigen ENVISU C2000 series handheld OCT products may allow doctors to more quickly image the optic nerve and retinas of, for example, blinded soldiers much closer to the time of injury than previous systems may have allowed. Uncooperative and/or intubated patients can be imaged with the Bioptigen ENVISU handheld. Intraoperative use of the Bioptigen ENVISU system may assist in the management of surgical ocular trauma, such as peeling proliferative vitreoretinopathy membranes and imaging intraocular foreign bodies. The ability to utilize the system intraoperatively may provide insights into surgical planes previously unrecognized.

The storage device 380 can be one or more storage devices. It may be external storage or local storage, i.e. incorporated into the image acquisition system 320 or the image analysis system 320, without departing from the scope of the present inventive concept.

The third party communications devices 390, 391, 392 may be, for example, a desktop computer 390, a tablet 391 or a lap top computer without departing from the scope of the present inventive concept. The communications device can be any type of communications device capable of communicating with the image analysis system 320 over a wired or wireless connection. Although only three communication devices are illustrated in FIG. 3, embodiments are not limited to this configuration. For example, more or less than three communication devices may be present without departing from the scope of embodiments discussed herein.

If the communications device is a portable electronic device, as used herein “portable electronic device” includes: a cellular radiotelephone with or without a multi-line display; a Personal Communications System (PCS) terminal that combines a cellular radiotelephone with data processing, facsimile and data communications capabilities; a Personal Data Assistant (PDA) that includes a radiotelephone, pager, Internet/intranet access, Web browser, organizer, calendar and/or a global positioning system (GPS) receiver; a gaming device, an audio video player, and a conventional laptop and/or palmtop portable computer that includes a radiotelephone transceiver.

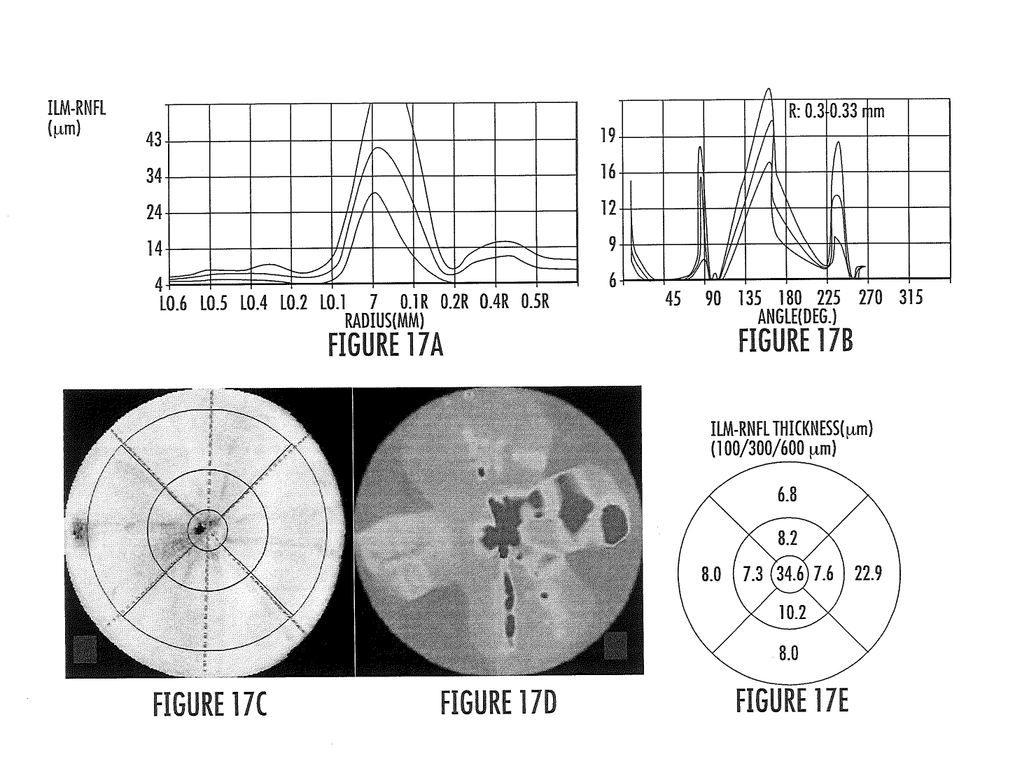

The reports 362′ and 362″ may include any information relevant to the image. Example reports are illustrated and discussed with respect to FIGS. 17A-E below.

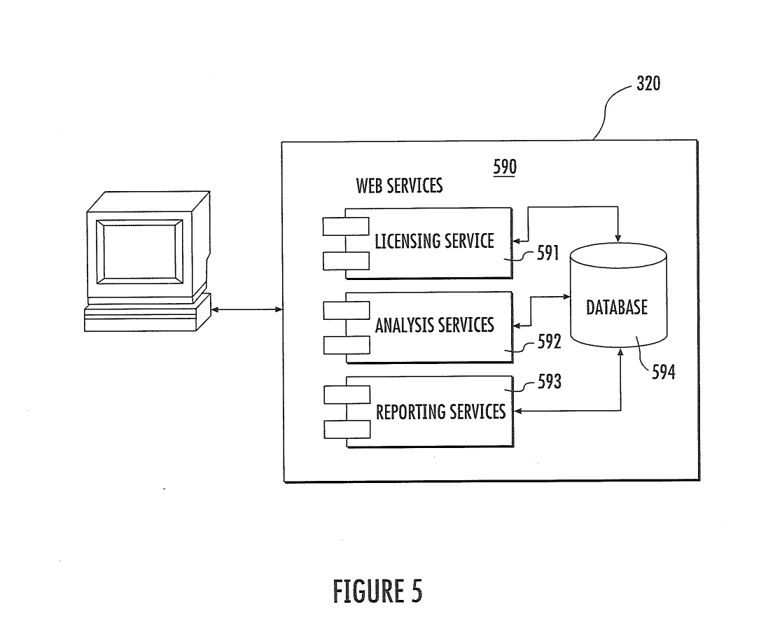

Referring now to FIG. 5, one aspect of systems in accordance with some embodiments of the present inventive concept will be discussed. As illustrated in FIG. 5, the image analysis system 320 may include a web services application 590 including various components, for example, a licensing service component 591, an analysis service component 592 and a reporting services component 593. As further illustrated in FIG. 5, each of these services 591, 592 and 593 are connected to a database 594. The web services application 590 of the analysis system may provide analysis and reporting services to the imaging system in accordance with some embodiments of the present inventive concept. For example, the web services application 590 is configured to provide additional post-processing functionality, for example, to automatically segment retinal layers of small animal (mouse) models for pre-clinical research such as 3-boundary layer segmentation of the Inner Limiting Membrane (ILM), the outer edge of the Retinal Nerve Fiber Layer (RNFL), and the outer edge of the Retinal Pigment Epithelium (RPE) in mouse retina models.

As discussed above and illustrated in FIG. 5, the services may include, but are not limited to: a Licensing Service component 591 configured to validate that the local host is licensed to run the requested analysis method(s); a collection of Analysis Service modules configured to apply any number of available analysis methods to image data; and a Reporting Service module configured to generate reports using predefined data sources and queries.

In particular, when the analysis system 320 is invoked a call is made to the Licensing Service module to determine what analysis packages are licensed on the local computer and the user interface is dynamically populated with controls specific to each of the analysis packages. A user selects a scan to process and clicks on the user interface (UI) control for the desired analysis. The filename is passed to the Analysis Service module 592, which is configured to apply an analysis method to the file and passes any result data and a unique GUID measurement ID linked to that filename to the Database 594 and returns a status flag and the measurement ID. If the analysis service module 592 does not experience and an error, the Reporting Service module 593 is called with the measurement ID and report type. The Reporting Service module is configured to use a reporting service such as MS Reporting Services and the requested report template to generate the analysis report using data from the Database 594, displaying the report in a web browser. In some embodiments, the report may be saved as a file, for example, .pdf or .xps, or exported to an external application, such as, Excel for further analysis. As discussed above, the quantitative results are stored in totality in the reference database 594, thus, becoming secondary data elements for further statistical analysis and tertiary image processing applications as will be discussed further below. Accordingly, all numerical results may be available to the clinician and researcher for increased re-use of data.

It will be understood that as used herein “reference database” refers to a central database including information and metadata associated with a plurality of patients/subjects. As will be discussed further below, this reference database can be used in combination with the “hypercube” in accordance with embodiments discussed herein to provide more accurate query results for clinical and research purposes. It will be understood that the database is dynamic as it gets updated with each subjects' specification information. As the sample size gets bigger, the results based on the information stored in the reference database become more useful/accurate.

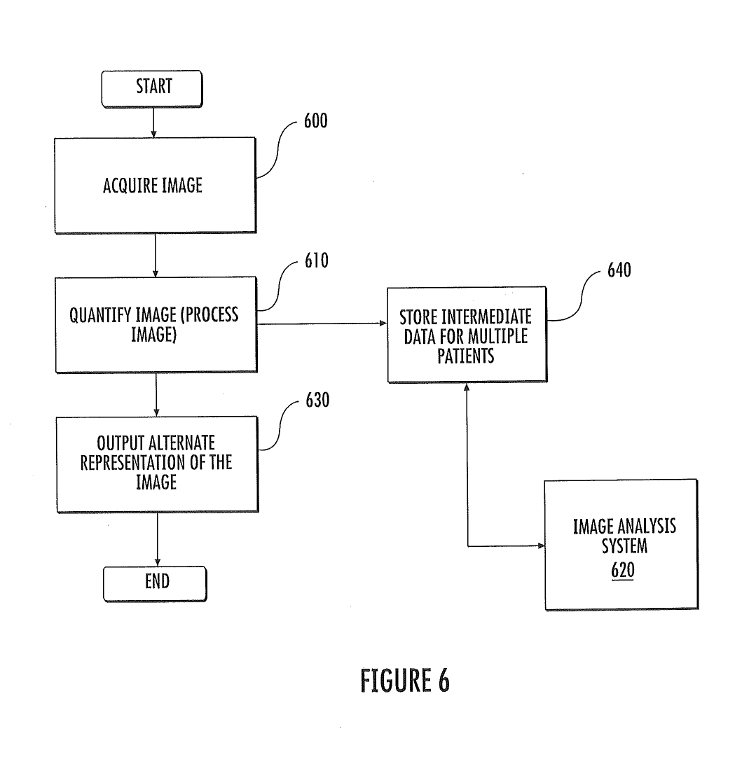

Referring now to the flowchart of FIG. 6, operations of the system illustrated in FIG. 5 will be discussed in accordance with some embodiments of the present inventive concept. Operations begin at block 600 by acquiring an image. It will be understood that the image may be acquired from an image database or may be directly provided from the image capture system without departing from the scope of the present inventive concept. The image may undergo a quantification process (block 610) during which various abstractions/representations of the image may be produced. These abstractions/representations, referred to generally herein as intermediate quantitative data sets, may be stored along with metadata (block 640) for future use. Examples of such abstractions include without limitation: a line or functional representation of a line that describes a boundary layer identified in a B-scan, or depth-resolved cross-sectional image; a surface or a functional representation of a surface that represents a boundary layer identified across a multiplicity of B-scans or a volume of an image; a volume or a functional representation of a volume that represents a particular volume, or void or abscess or the like; a set of data that defines a distance between point, lines or surfaces of an image, such a data set suitable for forming a thinkness map, or “heat” map of a region; a texture map or a histogram representing intensity variations or intensity values within an image or region of an image. As discussed above, conventional systems typically discard this intermediate data or do not make this data available to the public. Embodiments of the present inventive concept realize that this intermediate date may be useful for clinical and research purposes and, thus, this intermediate data is stored (block 640). The data is stored with data for multiple patients and thus may be queried and searched to provide more accurate information to clinicians and researchers. In other words, the more samples and data acquired, the more accurate the results of the query to the image analysis system. It will be understood that the personal information of the patient may be stripped from the database to ensure compliance with HIPA regulations. In other embodiments, the data may be password protected and allow access only to those in compliance with HIPA regulations.

After the intermediate data is stored (block 640), the desired representation of the image may be output (block 630). This representation of the image may also be stored (block 640) in accordance with some embodiments of the present inventive concept.

As further illustrated in FIG. 6, the stored intermediate data for all patients may be accessed by the image analysis system 620 to identify relationships based on any relevant criteria. These relationships may be stored and then searched with the intermediate data to further clarify the results. Thus, embodiments of the present inventive concept provide a dynamic system where the reference module is constantly changing with every additional patient and every additional query made.

As discussed above, in a telemedicine environment the relevant medical data must be transmitted in real time to a remote provider to enable provision of proper and timely medical treatment. Thus, embodiments of the present inventive concept provide an alternative method of transmitting this information (acquisition model) as discussed in detail below.

Referring first to FIG. 7A, the acquisition session illustrated therein involves starting an acquisition session (700), entering into an aiming mode to align the beam relative to the eye (710), starting the image acquisition to a circular buffer in RAM (715), saving the data (730), processing the raw data buffer (740), and displaying the results (750). If the data is acceptable, it is saved from the circular buffer to a location on the hard disk (760) and the results may be accessed therefrom (770).

Referring now to FIG. 7B, file streaming formats systems in accordance with embodiments of the present inventive concept (the “BPN stream”) enables a different approach to data flow in which the stream can be added to at any point in time, removing the need for the RAM buffer through direct stream-to-disk persistence. This data streaming architecture can be particularly important for forward based instrumentation with the need for immediate expert support but with limited data transfer bandwidth. For example, in the present mode of operation (FIG. 7A), the medic aims, acquires a single scan (which can be on the order of 200 megabytes (MB) in size), transmits, waits for successful transmission, and receives feedback.

In embodiments of the present inventive concept (FIG. 7B), the medic aims and explores, data is being continuously transmitted in small “Blobs” 781 as shown in 7B that are kilobytes (KBs) in size. As used herein, a “blob” refers to any portions or section of an image, for example, an A-Scan or section of an image. The blob 781 may include data of a particular type, for example, video, OCT, metadata. In embodiments illustrated in FIG. 7B, data may be received asynchronously and reassembled into contiguous images remotely, as all relational information is contained within the metadata (byte) 783 associated with each blob. The byte 783 may include any type of data useful to the end user, for example, OCT data, camera rate, lateral speed, position target and the like. This streaming architecture in accordance with embodiments of the present inventive concept enables real-time telemedicine, and is particularly valuable for forward instrument deployments.

In more detail, file streams may have multiple Readers and Writers, i.e., entities that either read or write data from or to some point within the stream. Readers and Writers may be asynchronous, for example, a Writer writes data to the stream as it is acquired, a Reader passes stream data to an analysis service for real-time blob analysis of newly acquired data, the same analysis service uses a Writer to change previously acquired stream data to a truncated form containing only the region around the blob containing the retinal information content, and a Reader attached to a communications service sends the revised stream data over a network bus for remote viewing of the image data of interest. This is all performed on the same data entity—the stream. The stream resides on either local or remote storage and can be indefinitely long as needed by the imaging system.

As illustrated in FIG. 7B, a Reader is synchronized with position of a type attribute in order to process it. With a stateful stream approach, the operator does not have to take special actions to initiate or stop data acquisition. Embodiments discussed herein allow for an “always on” operation when the data stream itself contains all descriptive information that is used by its Readers to perform any necessary processing, analysis, presentation, or reporting. Thus embodiments illustrated in FIG. 7B are clear distinct from the common acquisition approach illustrated in FIG. 7A where the operator has to synchronize instrument acquisition with the patient position and state. A streaming architecture in accordance with embodiments discussed herein gives the operator the ability to receive the same outcome more efficiently, reducing, or possibly eliminating, the need for repetitive actions that might be necessary in the prior sequence, however, multiple acquisitions may be needed to acquire the desired data. With streaming there is no need to perform any of the actions required in the traditional sequence. The operator simply uses an “always on” instrument and the data stream is processed and analyzed simultaneously with acquisition as illustrated by the diagram of FIG. 7C. The stream analysis gives the operator real-time feedback on when acquisition may be interrupted. This feedback may be passed as a report output or be integrated into decision support logic to trigger the interruption when the established results criteria are met, for example, mark the stream state as “retina image start” when a quality indicator has flagged the last acquired frame as a high quality retina image.

The BPN stream is a stateful object that derives from a continuous data stream that is unlimited in both size and duration. The state information of the stream contains an arbitrary set of attributes of a priori defined types. The stream may have multiple writers and multiple readers in a way that additional data or additional attributes may be embedded into the data stream. A Reader reconstructs the timeline of stream operations through sequential, serial, incremental processing of the stream attributes. An example of the states could be patient ID, X and Y positions of the beam-scanning galvos, detector exposure time, blood pressure, or pulse rate. As the Reader processes each of the attributes and establishes the state of the stream, the Reader can be converted to a Writer to modify stream attributes as needed. A stream may be branched into multiple copies of a stream to enable persistence of raw data and a processed data stream.

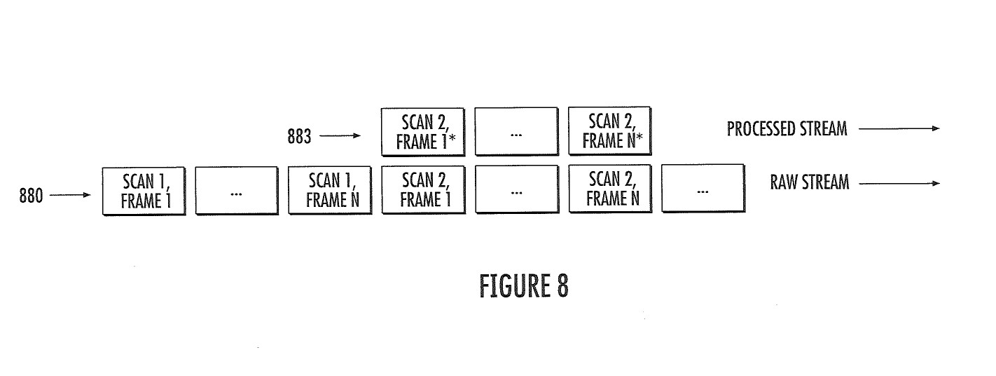

As illustrated in FIG. 8, an analysis service may branch a stream 880 to persist the raw data while capturing analysis results in a processed stream 883. Branching streams as illustrated in FIG. 8 requires storage and processing to support the additional stream. Multiple copies of streams may not be feasible on a mobile imaging system, but in accordance with embodiments of the present inventive concept including a server/cloud solution will have sufficient horsepower to enable running multiple analysis methods on processing streams concurrently.

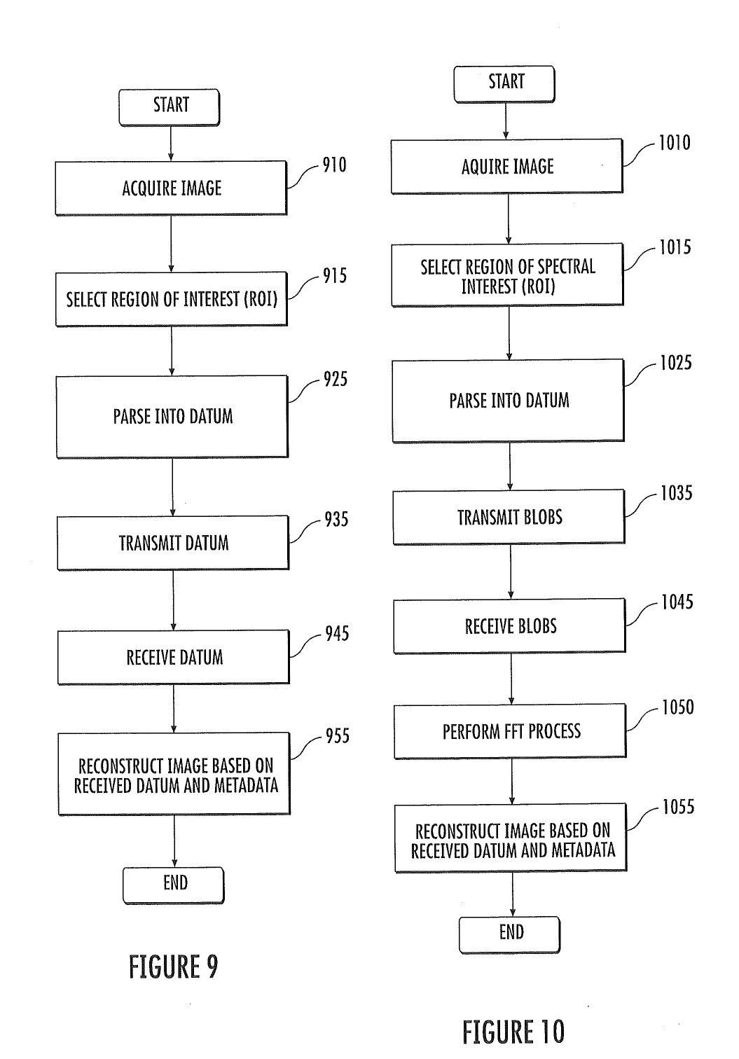

Referring now to the flowcharts of FIGS. 9-11, operations of data acquisition in accordance with some embodiments of the present inventive concept will be discussed. As discussed above, image data can be continuously streamed in “blobs” as it is acquired in the remote location, for example, the battlefield or some remote portion of the country. The blobs are dynamic based on the environment and can be reassembled at the receiving end based on information provided in the metadata associated with the blob. In some embodiments, the data may be acquired synchronously and may be reassembled synchronously or asynchronously without departing from the scope of the present inventive concept.

Referring first to FIG. 9, operations begin at block 910 by acquiring an image. It will be understood that the image may be acquired using any practical method, however, in some embodiments, the image may be acquired using a portable imaging device such as the Bioptigen ENVISU. A region of interest (ROI) is selected in the image (block 915). As used herein, “region of interest” refers to the portion of the image illustrating the relevant portion of the image, i.e. the portion of the image illustrating the condition/disease in the patient that is trying to be resolved. In some embodiments, the region of interest may be the entire image depending on the relevance thereof.

The region of interest is parsed into datum (block 925), for example, the image received directly from the imaging device may be parsed in to a processed image to provide the datum. The datum may be transmitted (block 935). It will be understood that the datum may be transmitted using any method available, for example, Bluetooth, WiFi, wired network connection and the like. However, it will be understood that images obtained in the field are more likely to be transmitted in a wireless fashion. The datum is received at the end point (block 945) and reconstructed (block 955) based on the datum received and the metadata associated with the blob.

Referring now to FIG. 10, in some embodiments, the acquired image may be transmitted in the frequency domain. Transmitting the acquired image in the frequency domain may require minimum processing locally and may offer additional security because no actual image data is being directly transmitted; additional information that operates as a key, such as spectral calibration parameters and dispersion correction parameters may be required to process the spectral domain data into meaningful spatial domain data. As illustrated in FIG. 10, operations begin at block 1010 by acquiring an image. It will be understood that the image may be acquired using any practical method, however, in some embodiments, the image may be acquired using a portable imaging device such as the Bioptigen ENVISU. A spectral region of interest (ROI) is selected (block 1015). The region of interest is parsed (block 1025) and the datum may be transmitted (block 1035). The datum is received at the end point (block 1045) and a fast Fourier transform (FFT) process is performed using a key (block 1050). It will be understood that the key could be embedded in the metadata and transmitted with the image datum or stored in the hardware/user configurations without departing from the scope of the present inventive concept. After the FFT process (block 1050), the image may be reconstructed (block 1055) based on the datum received and the metadata associated with the blob. This information may then be send to an image analysis system in accordance with embodiments discussed herein for further processing.

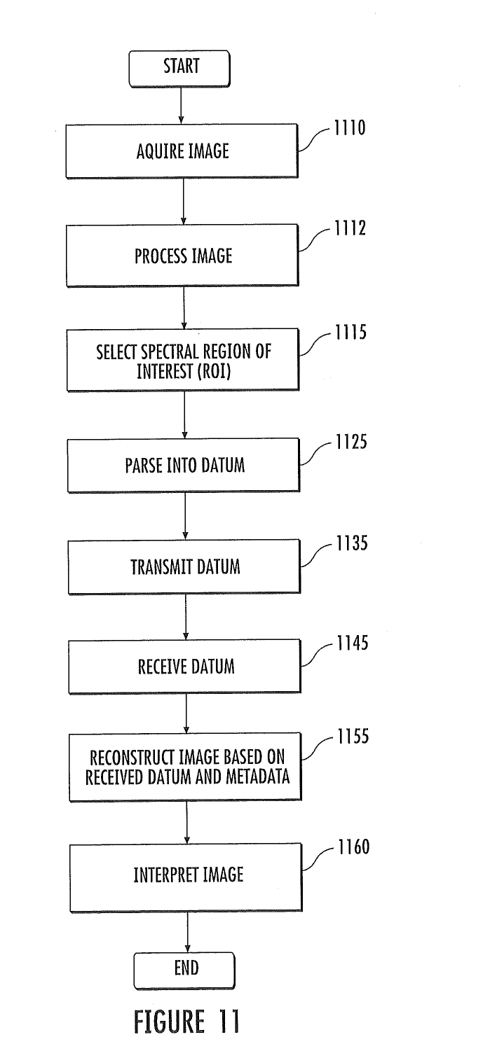

Referring now to FIG. 11, in some embodiments, the acquired image may be transmitted in the spatial domain. Transmitting the acquired image in the spatial domain may require minimum bandwidth (KBs in size) and can be reconstructed based on information in the metadata. As illustrated in FIG. 11, operations begin at block 1110 by acquiring an image. The acquired image may be processed (block 1112) and a spatial region of interest (ROI) is selected (block 1115). The region of interest is parsed (block 1125) and the datum may be transmitted (block 1135). The datum is received at the end point (block 1145) and reconstructed (block 1155) based on the datum received and the metadata associated with the blob. The image may then be interpreted 1160 by an image analysis system in accordance with embodiments discussed herein.

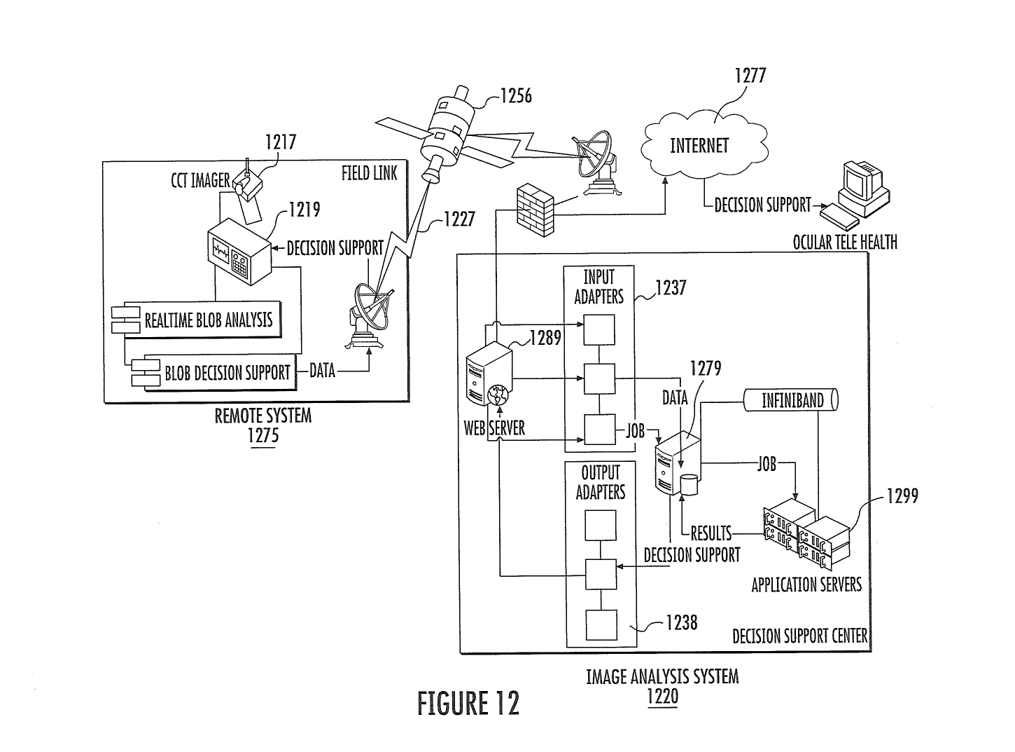

Referring now to FIG. 12, a block diagram of a system in accordance with some embodiments of the present inventive concept will be discussed. As illustrated therein, the system includes a remote system 1275 and an image analysis system 1220 in accordance with embodiments discussed herein. The remote system 1275, for example, in battle field or rural America, includes an image capture device (OCT imager 1217), a means for transmitting the acquired images in “blobs” 1227 (wireless transmission to satellite 1236) as discussed above and a device allowing communication with the remote medical providers 1219, for example, a two way radio or satellite telephone.

As further illustrated in FIG. 12, the image data sent from the remote system 1275 may be stored at a server 1279 associated with the image analysis system 1220 or in an Associated Internet cloud 1277. The medical personnel providing the Decision Support have access to one or both of these storage areas.

The image analysis system 1220 in combination with the remote system 1275 enables acquisition in the field; streaming of the BPN stream to the cloud 1277 or a network server 1279; marshalling of the BPN stream by a Web Server 1289 through a variable number of Input Adapters 1237 that manipulate the data as necessary based on the current job; automatic query execution and data routing through a SQL Server; transport through an Infiniband controller to a bank of Application Servers 1299 for job-specific processing; return of results to the SQL Server; application of Decision Support tools based on the returned results; modification of the data stream through Output Adapters 1238 to prepare the data for consumption; marshalling of the output data stream(s) through the Web Serve 1289; and transmission of the output data stream(s) back to remote system 1275 on the field unit or to the cloud 1277 for remote viewing, for example, for telehealth expert screening.

In some embodiments, cloud based embodiments may target both the Microsoft Azure platform and the Amazon AWS GovCloud along with the Amazon S3 service. For prototype cloud deployment, large on-demand EC2 windows and SQL Server units will be used with training data tests size limited to 100 GB. In some embodiments, the cloud may be scaled up to Cluster Compute Reserved Instances with Light, Medium, or Heavy utilization as necessary.

Some embodiments of the present inventive concept enable custom, user-generated reports to facilitate user control of data reporting. As will be discussed further below, queries relevant to most users may act as data sources for user-generated reports, for example, create a table of the total retinal thickness and total RNFL thickness for the patient defined in the Patient_Name field in the report template.

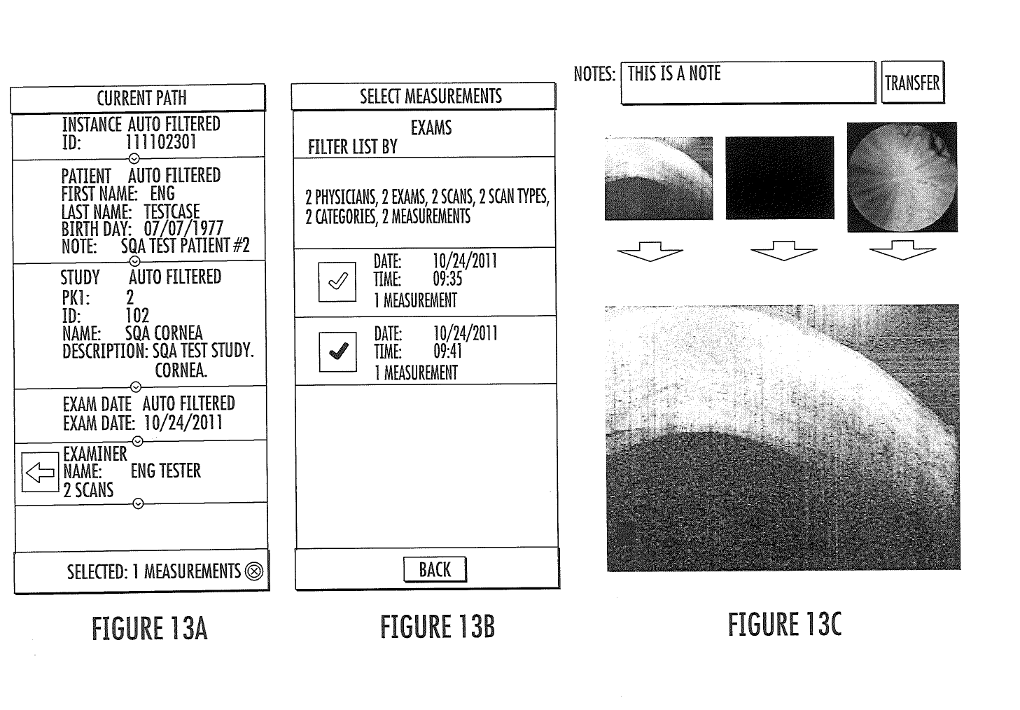

Some embodiments of the present inventive concept may provide a user-friendly web interface for interacting with the image analysis system that includes a “hypercube” query tool for developing and storing queries, visualization, annotation, and manipulation of processing and statistical results as will be discussed further below. As illustrated in FIGS. 13A-13C, the hypercube interface may include storage of queries in a “shopping cart” like bin, annotation and manual manipulation of processing results (e.g. segmentation layers) and statistical results (e.g. adjusting confidence intervals).

Data is browsed as illustrated in FIG. 13A by selecting any number of metadata parameters including but not limited to patient ID, physician name, or exam date, and drilling down to individual exams or scans as illustrated in the Select Measurements window in FIG. 13B. Data sets may be selected at any point in the hierarchy, for example, all data for a physician, an exam date, or a scan type may be selected using the hypercube interface. The current selection of metadata parameters used to filter the data is shown in the Current Path window of FIG. 13A. If a single scan is selected, a B-Scan from the OCT file, the associated fundus image (if it exists) and the volume intensity projection are shown in the image preview window illustrated in FIG. 13C. The hypercube interface may be Silverlight control which can be published as part of a WPF application, distributed as a standalone executable, or published to a web server for browser-based operation without departing from the scope of the present inventive concept.

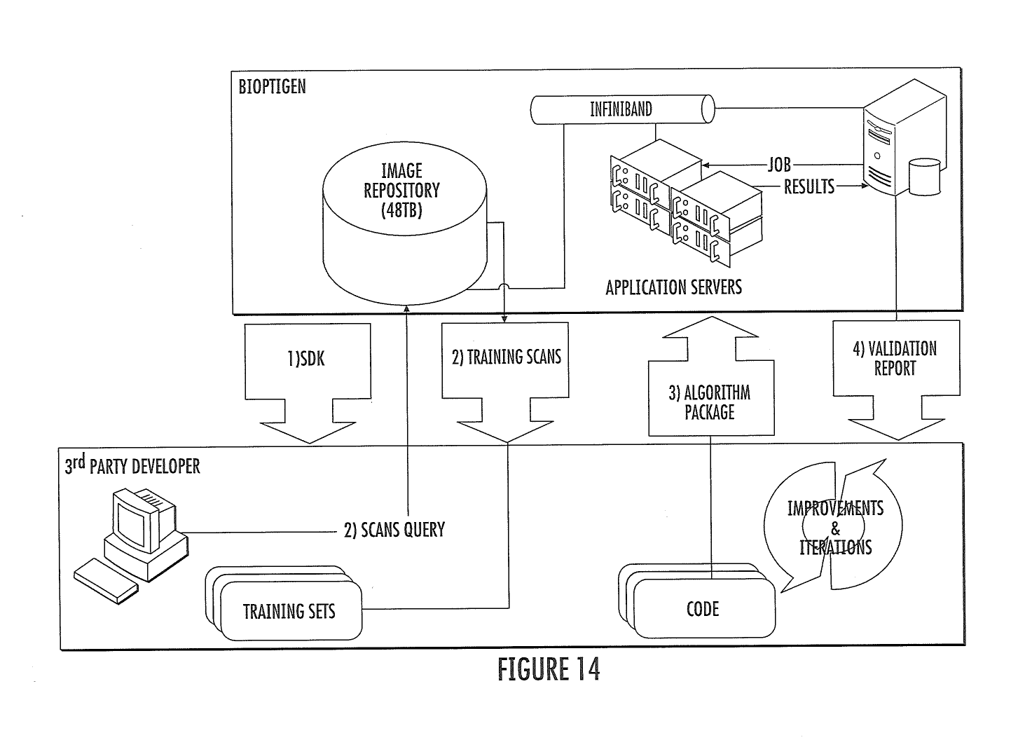

Referring now to FIG. 14, some embodiments of the present inventive concept (Software Development Kit (SDK) (1)) may enable 3^{rd} party developers to use the image analysis system in accordance with embodiments of the present inventive concept to run queries against the database of image data (Image Repository 48TB) (2) to pull image data against which to develop and validate image processing algorithms, push those algorithms to the server (3) for validation against the full bank of relevant image data, and view a report (4) on the image processing validation against the entire collection of relevant scans.

By way of example referring to FIG. 14, some embodiments of the present inventive concept may be used to develop automated cornea layer segmentation and trauma identification algorithms, query the image database for healthy and injured cornea, pull the data to their local network for algorithm development and training on local systems, push the algorithms as a new set of analysis methods to the Application Servers for validation against all healthy and injured cornea stored in the Miner Image Repository, and view a report on the segmentation results across all relevant cornea data sets to determine if the training data sample was a reasonable approximation for the data population and to evaluate segmentation failure modes for iterative improvement of the algorithms. These embodiments may allow identification of clusters of known failure modes, for example, if the image is dim within the first third of the imaging window and the cornea curvature is extreme as the patient has keratoconus, then the segmentation for healthy cornea will fail, enabling triage of critical segmentation failures. In further embodiments, validation results may indicate success or failures across clusters of data, providing for feedback on algorithm improvement against a large array of image types and failure modes.

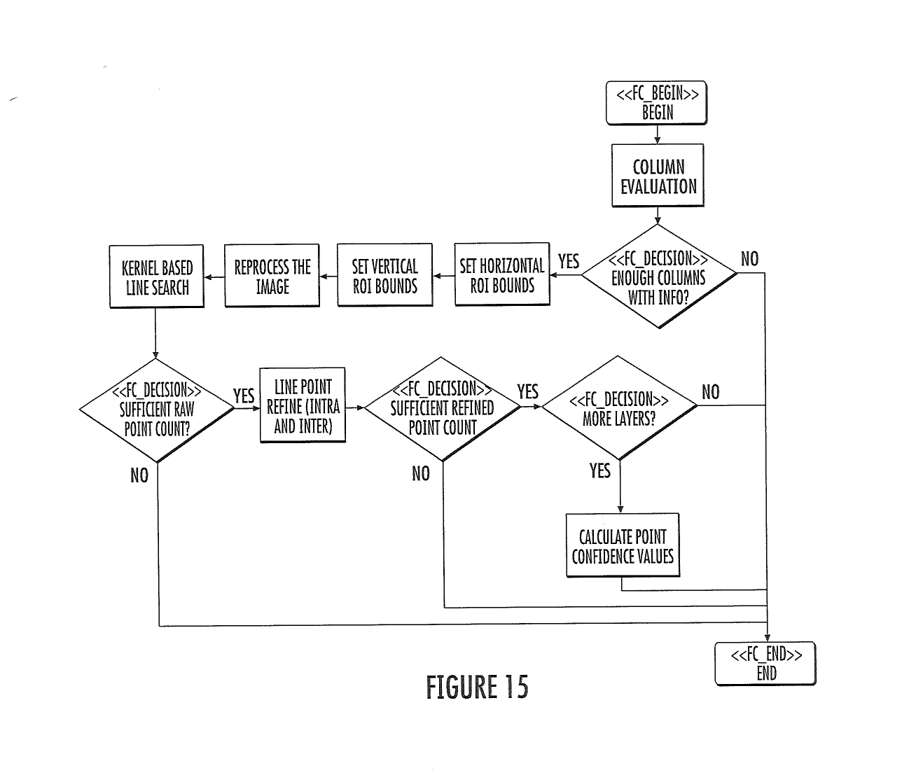

Referring now to FIG. 15, a flowchart illustrating operations of image segmentation for automated mouse retinal boundary segmentation in accordance with some embodiments of the present inventive concept will be discussed. Systems in accordance with some embodiments include automated segmentation of physiological layers, for example, layers of the retina or cornea, and automated centration of a diagnostic grid to physiological landmark, such as the ETDRS grid standard for the macula. The resultant data is statistically rich, derived from up to 150,000 (depends on scan type and available network bandwidth) depth resolved A-scans segmented into up to eight histologically relevant layers. This resultant cube of data, with, for example 8 segments per 9 regions of the ETDRS grid, can be analyzed using statistical tools to test against normative data, or test for equivalence between subjects. In some embodiments, these systems include a set of common statistical tools, such as ANOVA, and simple reporting mechanisms to export such reduced data to an external application, for example, Excel, for ease of manipulation.

In order to expand the utility of systems in accordance with embodiments discussed herein, the analysis system includes Application Programming Interfaces (APIs) to allow third-parties to develop and integrate additional tools. Such tools may add additional structural analysis, volumetric analysis, and functional analysis from spectral properties and phase properties, for example, Doppler flow. As tools are developed and implemented, existing data can be reprocessed without having to continuously collect new data to test new hypotheses. These APIs will extend to statistical tools to create a vibrant and living data sharing and analysis environment.

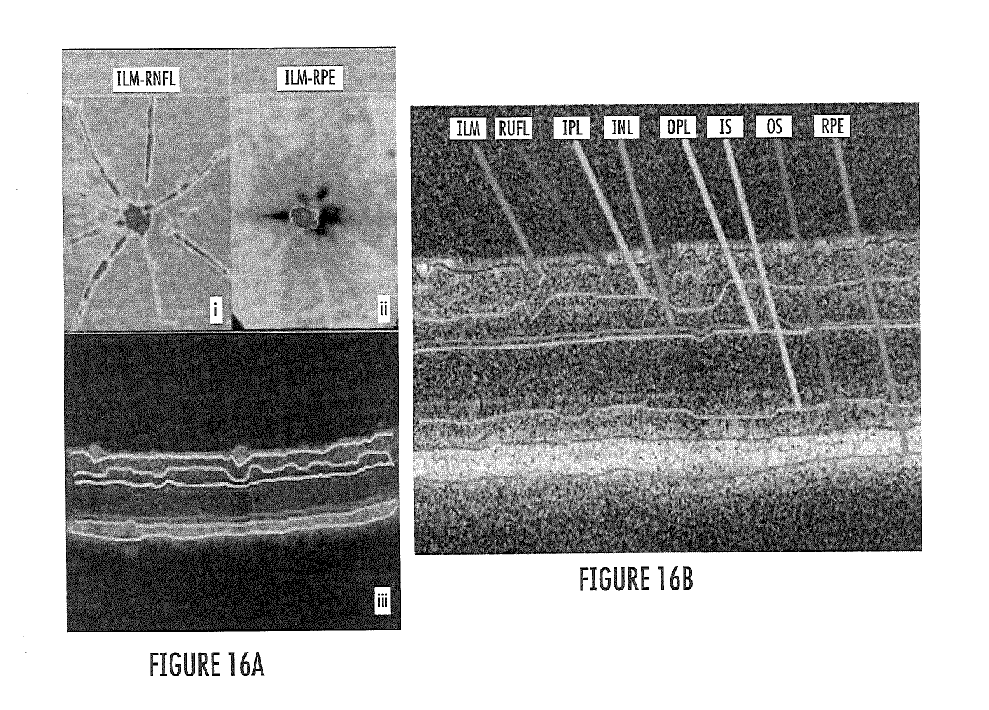

Current image segmentation methods are performed on both a depth profile (A-Scan) and image-wide (B-Scan) or kernel-wide (B-Scan subset) basis. As illustrated in FIG. 15, the algorithm first evaluates all A-Scans to determine if sufficient image data exists, for example, few regions of low contrast or missing image data, to perform segmentation. If this test passes, a “blob” analysis is performed to find the region of interest (ROI) that contains the retina image data. A collection of smoothing, edge detection, and peak finding methods tailored to finding each of the retinal layers may be applied, and the segmentation results and confidence of detection may be reported back to the analysis service calling the segmentation method. Data/Scans resulting from this analysis are illustrated in FIGS. 16A-B and 17A-E.

In particular, FIGS. 16A-B illustrate scans generated using automated mouse segmentation. FIG. 16A illustrates automated segmentation of the mouse retina with reports that include thickness map generation of the retinal nerve fiber layer and ganglion cell layer (i) and full retinal thickness (ii) and scans showing the segmentation of 8 boundary layers (iii). FIG. 16B indicates the boundaries found with the automatic segmentation algorithms. These include the Inner Limiting Membrane (ILM), the outer edge of the Retinal Nerve Fiber Layer (RNFL), the outer edge of the Inner Plexiform Layer (IPL), the outer edge of the Inner Nuclear Layer (INL), the outer edge of the Inner Plexiform Layer (IPL), the inner edge of the Inner Segment/Outer Segment (IS/OS) boundary, the outer edge of the IS/OS boundary, and the outer edge of Retinal Pigment Epithelium (RPE) layer.

FIGS. 17A-E illustrate an exemplary report produced for these results. As illustrated therein, the automated mouse retina segmentation report contains thickness results averaged over all angles at a fixed radius (FIG. 17A) and averaged over the radius 0.3-0.33 mm for fixed angles (FIG. 17B). The report also contains a Volume Intensity Projection (VIP), an en face projection of some or all the depth-resolved data, generated from the B-Scan data (FIG. 17C), a Heat Map to indicate local variations in thickness for the layers in question (in this case the ILM and RNFL) (FIG. 17D), and an ETDRS-like grid showing thickness averaged by quadrant in 100, 300, and 600 micron diameter rings (FIG. 17E). The Heat Map (17D) has a color scale that maps the maximum and minimum display colors to the mean thickness of the layer±1 standard deviation of the thickness, highlighting regions with extreme values, for example, the retina vessels segmented in the RNFL will provide thicker values than the surrounding tissue. In some embodiments, the report contains basic patient information metadata as collected at the time of acquisition, information on segmentation quality (how many A-Scans were successfully segmented per B-Scan) and automated centration quality (how well the analysis method was able to find the center of the nerve head on the VIP), and a data table indicating the maximum, minimum, mean, standard deviations, and segmentation quality within each of the regions of the ETDRS-like grid.

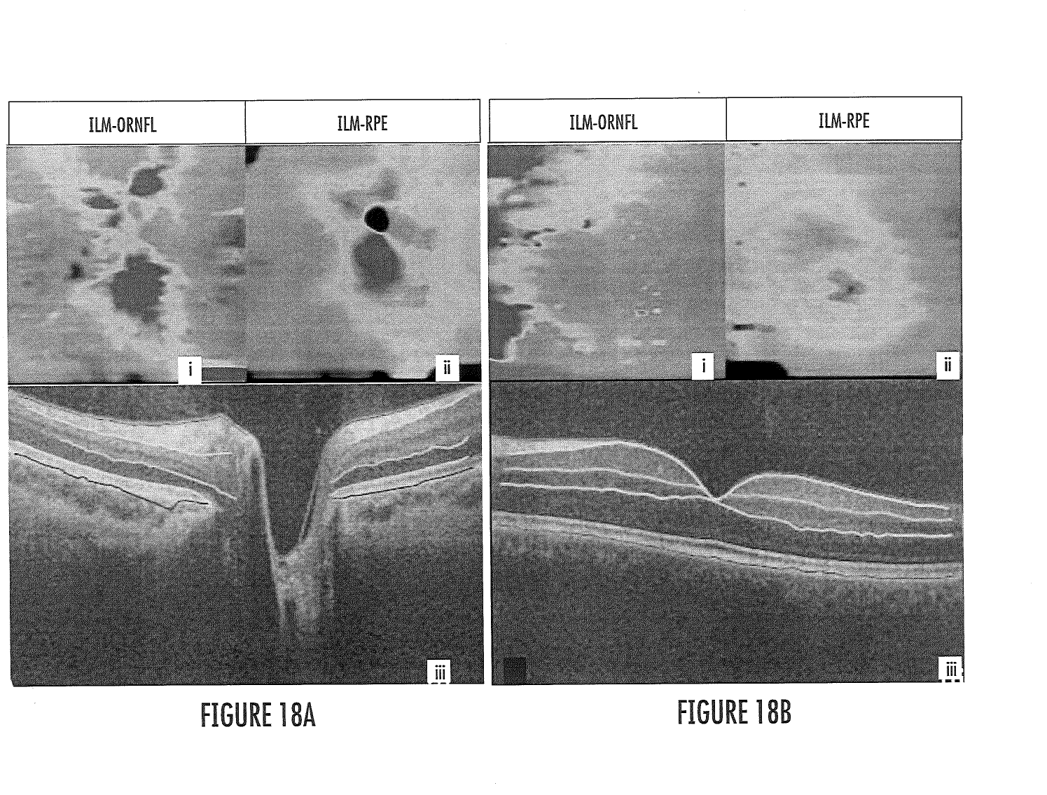

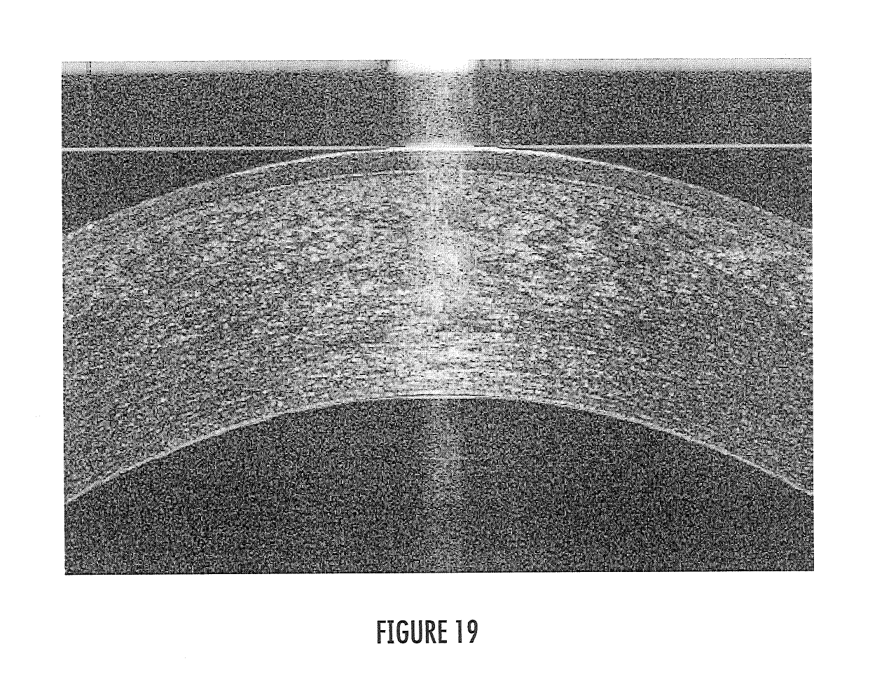

Referring now to FIGS. 18A and 18B, scans illustrating preliminary multilayer human retina segmentation will be discussed. The segmentation results shown in FIGS. 18A (i-iii) and 18B (i-iii) were generated from a healthy human retina; the segmentation results break down quickly in the presence of ocular trauma or disease. An example of preliminary cornea segmentation is illustrated in FIG. 19, the upper curved line illustrates segmentation of the anterior epithelial and the lower curved line illustrates segmentation of the posterior endothelial layers. Some embodiments of the present inventive concept are configured to accurately segment or flag for review structural anomalies related to retinal or corneal disease or injuries. These embodiments are able to detect and quantify blast-related maculopathy and retinopathy. Further embodiments may be used to design and validate processing methods against healthy data first to confirm algorithm operation on normative data. These new segmentation methods may be validated against trauma or disease data acquired.

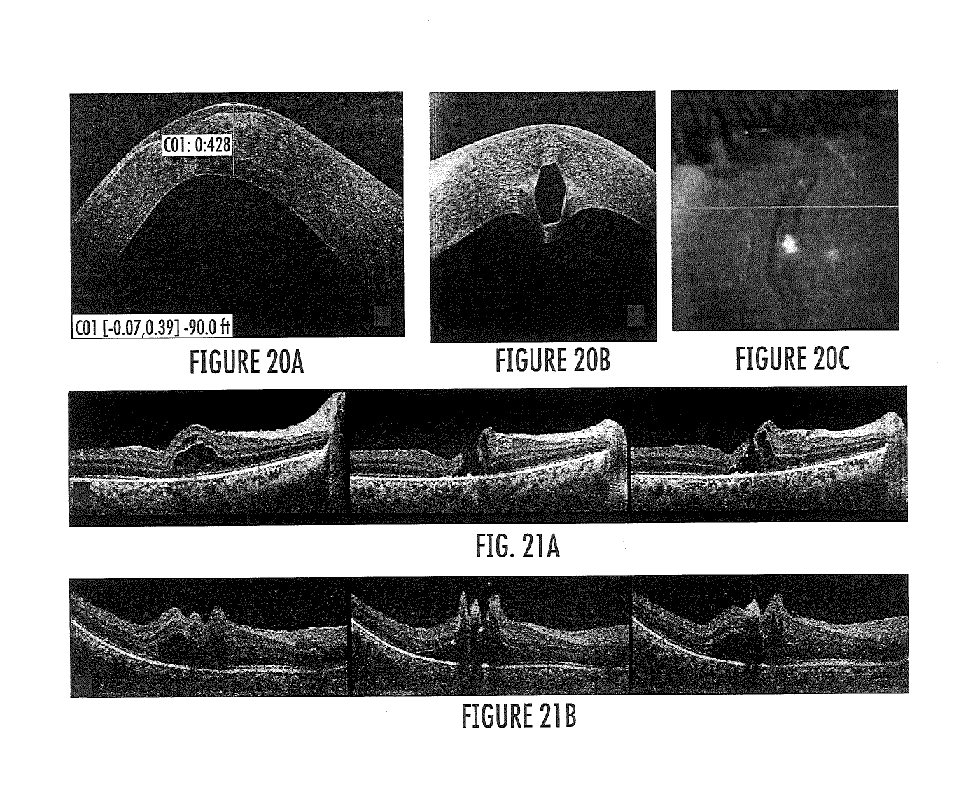

The portable imaging system, for example, Bioptigen ENVISU mobile imaging system, has been used to image both anterior (FIGS. 20A-C) and posterior (FIGS. 15A-B) trauma and disease. Application of image processing and statistical analysis of FDOCT images could be used as decision support tools for telehealth applications. FIG. 20A illustrates an image acquired on a patient presenting with keratoconus; FIGS. 20B and C are a B-Scan and VIP of a support ring inserted into the cornea to correct for keratoconus. FIG. 21A is a collection of images of a partial macular hole acquired before surgery and FIG. 21B is a collection of images acquired at the same locations in the retina immediately following hole repair.

FDOCT Data Analysis and Mining Systems in accordance with some embodiments discussed herein may open new avenues in telemedicine, as experts are able to access and analyze data remotely with state of the art tools. The System improves economics of research in ocular health care as data and associated metadata may be reused to test new hypothesis, and as clinical conclusions drawn may be shared and retested with new algorithms as they are developed and made available.

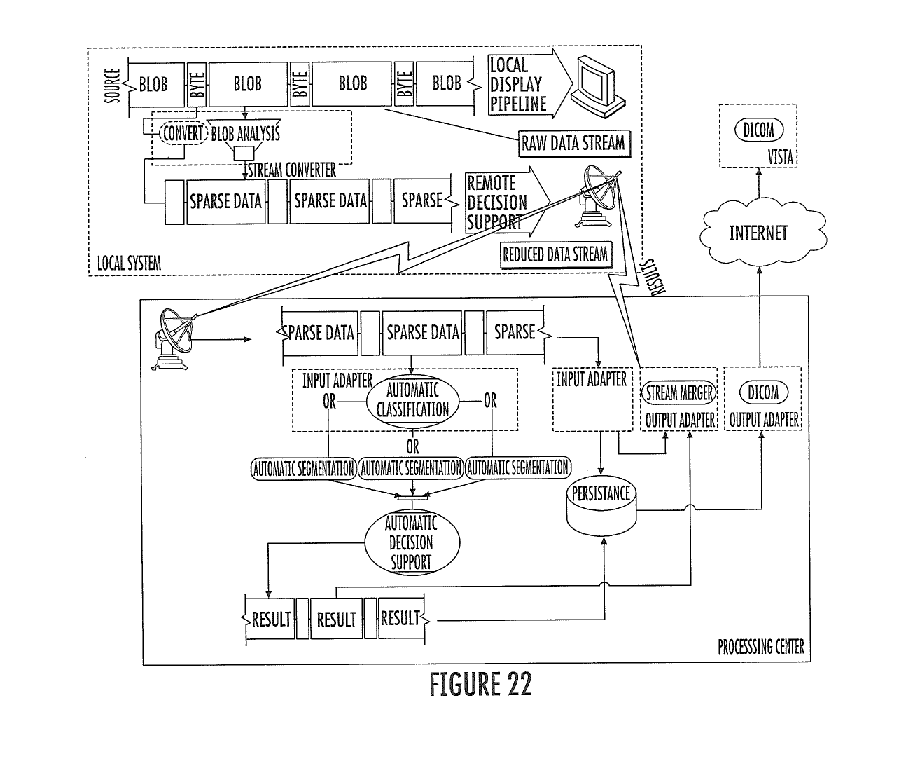

Referring now to FIG. 22, a block diagram of a complete system for streaming of OCT data from a mobile FDOCT system through a server solution to a review workstation for real-time or near real-time FDOCT data will be discussed. Generally, images acquired on the mobile imaging system (A) are streamed to a cloud or network-based server for stream processing and analysis support (B) and are then returned to the field unit or transported through the web to an EHR or image management system for real-time or offline analysis (C).

An exemplary acquisition will not be discussed. As images are acquired using the mobile FDOCT system (local system), the BPN stream is operated on by a Reader tied to an analysis service that conducts a blob analysis to identify regions of interest and uses a Writer to convert the raw stream into a sparsely sampled stream that only contains the region of interest data, effectively decreasing the bandwidth required to transmit the stream to a Remote Decision Support system (Processing Center). The Sparse Data stream passes through 2 input adapters. The first manipulates the data for SQL Server marshalling to automatic segmentation analysis services on Application Servers as defined by the type of analysis job requested in the Sparse Data stream. Automatic decision support is provided through advanced analysis and aggregation of results. The Results Stream is stored on the server or in the cloud and passed back to the mobile imaging unit through an Output Adapter for field triage or diagnosis based on the decision support. The second Input Adapter passes the Sparse Stream to storage and converts the Sparse Data stream to a series of DICOM images compliant with EHR systems like VistA for remote viewing by an expert observer, who can in turn provide diagnostic support to the field unit. It will be understood that the system illustrated in FIG. 22 may be a networked server solution or a cloud-based solution without departing from the scope of the present inventive concept.

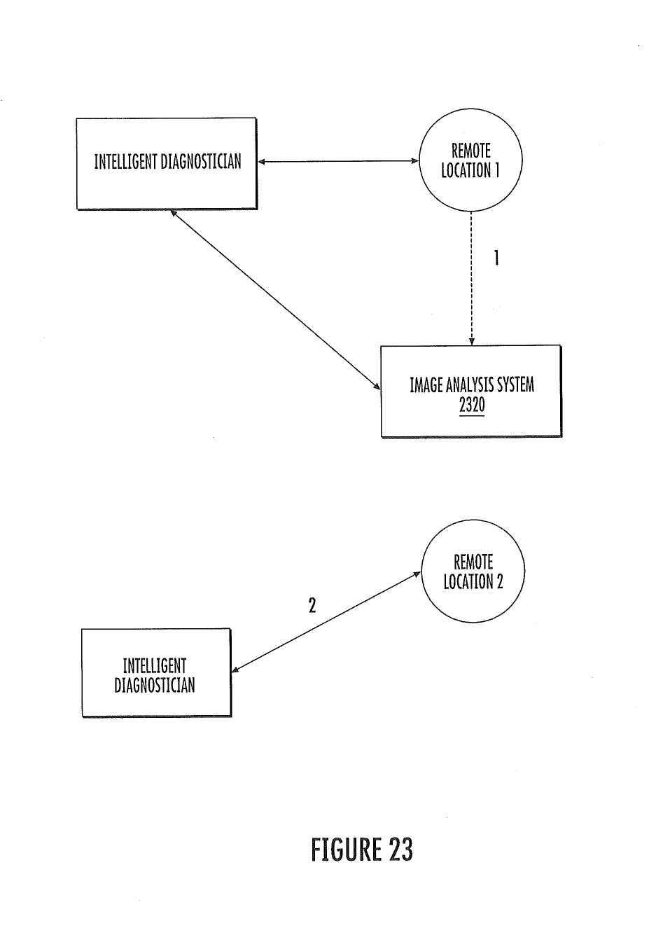

Referring now to FIG. 23, a block diagram illustrating an overview of the interaction between the remote locations 1 and 2, the intelligent diagnostician and the image analysis system. For example, as illustrated in FIG. 23, the data obtained at the remote location may go through the image analysis system 2320 before getting to the intelligent diagnostician (1) or may go directly to the intelligent diagnostician (2) without departing from the scope of the present inventive concept.

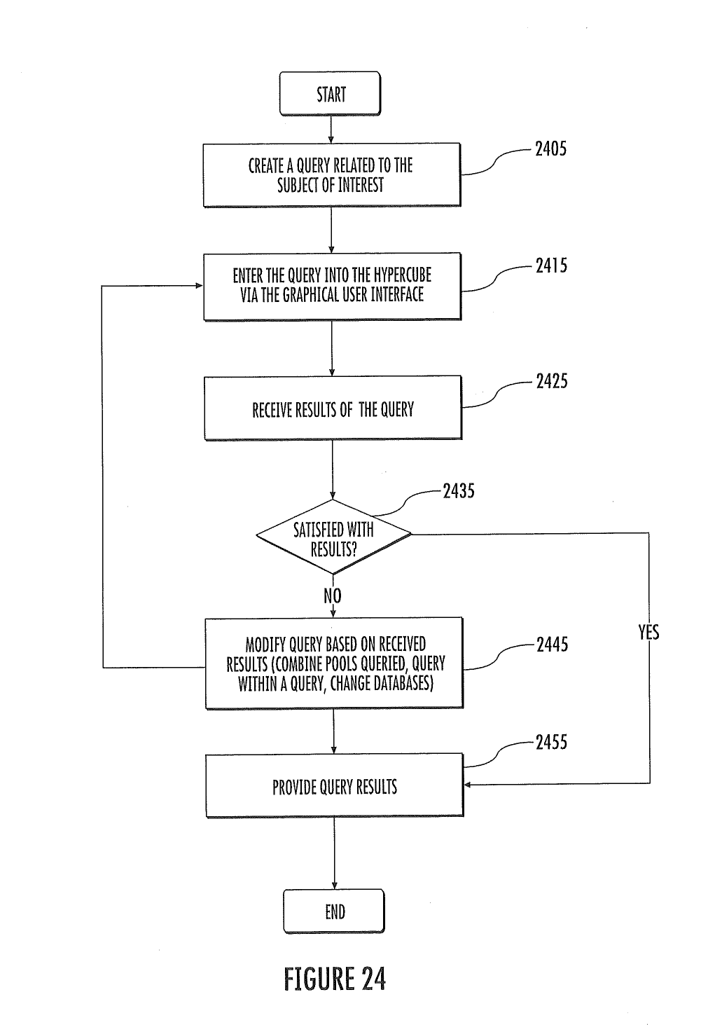

Referring now to the flowchart of FIG. 24, operations of the “hypercube” in accordance with some embodiments of the present inventive concept will be discussed. Operations begin at block 2405 by creating a query related to the subject of interest. For example, a query may include women from 35-37 years old having any problems with their retina. The query may be entered into the image analysis system using a graphical user interface associated therewith (block 2415). The image analysis system generates a series of results satisfying the query (block 2425). If the user is satisfied with the results (block 2435), the query results may be provided to an external application for user therein (block 2455). However, if the user is not satisfied with the results of the query (block 2435), the user may modify the query and operations may return to block 2415 until the user is satisfied with the query results (block 2435). For example, this query may be refined by combining these results with the results of another query or combing pools queried. For example, the queries for women ages 25-29 may be combined with the query for women ages 35-37. The databases being queried may be narrowed or expanded. The user may choose to query only in the results of the previous query. Thus, a disease specific application based filter may be created with multidimensional queries, new classifications may be created, and new standards of diagnosis may be established. As would be understood by those of skill in the art, the ability to query information from multiple sources in a multidimensional fashion may allow connections to be made among seeming unrelated data, which may lead to major advancements in patient diagnosis and subsequent care.

Thus, as briefly discussed above, systems in accordance with some embodiments of the present inventive concept can process and analyze patient data either locally or in the cloud, which is a powerful addition to existing EHR and telemedicine solutions for field, rehabilitative, and palliative care by enabling prescreening of complex data from imaging systems deployed to the field; aiding in diagnosis through the application of algorithms to compare current ophthalmic data to longitudinal, alternate, or normative data; and providing the infrastructure for more advanced telemedicine applications that require intense data mining or processing.

Establishing the infrastructure for remote processing and real-time streaming of decision support data to mobile ophthalmic imaging units is a vital first step to delivering advanced medical imaging systems to Forward and Mobile Operating Units. Integration with the existing VistA EHR and VistA Imaging platforms through VistA-compliant DICOM image data and standardized reports would improve the quality of care for, for example, wounded warriors in the field and at home and veterans undergoing rehabilitative or palliative care in the Veterans Affairs Health System.

As discussed above, embodiments of the present inventive concept are not limited to a military platform. For example, telemedicine for screening and triage of diabetic retinopathy has proven to be a successful and cost effective method for improving quality of care for patients suffering from complications of diabetes. Embodiments of the present inventive concept provide screening and diagnostic support for telemedicine applications and data mining capabilities for research and collaboration aimed at better understanding of the mechanisms of disease. No collaborative data management and analysis system exists to take advantage of the near-histological resolution of SODCT images.

Some embodiments of the present inventive concept may facilitate the pooling of data from multiple subjects for systematic analysis along multiple dimensions of inquiry. Some embodiments of the present inventive concept include a database to store metadata that contains state information about the subject (name, age, species, gender, ethnicity, other demographics, etc.) and a database to store results of processed images as discussed above with respect to FIG. 2. The results database effectively turns the unstructured raw images into a structured set of results. A multidimensional query (“hypercube”) may allow the researcher to search both databases for correlated sets of information along as many filters as there are fields in the metadata and results data base to create pooled data sets with a well defined set of relationships.

Some embodiments of the present inventive concept may provide prospective research design if facilitated by the system. Embodiments discussed herein may allow the definition of studies, subject populations, treatment arms representing aspects of the study, and end points for analysis. For example, the study may involve the assessment of treatments for retinitis pimentosa; the subjects may include a wild type mouse model and a retinitis pigmentosa mouse model; the treatments arms may include a pharmaceutical therapy and a genetic therapy; the endpoints may include total retinal thickness over time, outer nuclear layer thickness over time, ratio of inner nuclear layer to outer nuclear layer over time. Furthermore, the algorithms for obtaining the end point data may be in flux. Thus, embodiments discussed herein may allow for a priori definition of these and other classes of the experiment. As data is acquired and processed, results are collected and tagged with appropriate metadata, and pooled results analyzed along any or all dimensions of the study, and statistical methods applied to the results. All of this functionality may be accomplished on a single system, after data acquisition, with minimal manual intervention required beyond selecting filters for pooling data, methods for processing data, and statistical methods for analyzing data. Furthermore, the steps of selecting filters, processing methods and statistical approaches may be defined a prior, and the results automatically processed through to output on available data meeting the criteria. Further still, the processing may be run at anytime within the study, and rerun at any time in the study, for example as more data is made available. Furthermore, the pools may be changed by eliminating certain data sets according to new filters, re-running with new analysis algorithms, or re-running against new statistical tests for an original or modified hypothesis.

Some embodiments of the present inventive concept facilitate designed experiments, for example, Taguchi experiments, allowing the definition of multi-factor, multi-level experiments, reducing the full factorial design to a reduced design, specifying the factors and levels to be tested according to the design, tagging experimental results with their particular role in the design, automating the image processing per some embodiments of the present inventive concept, and automatically generating the statistical results, for example, an ANOVA to assess the relative impact of the various factors. In some embodiments of the present inventive concept multiple endpoints (algorithms) may be attached to the experiment, and further that the experiment can be re-processed on existing data with new end-points or improved or modified methods.

Some embodiments of the present inventive concept increase the reuse of image data. All available data may be reprocessed as described using new or revised image processing or data reduction methods, and results from processing method may be compared against results from another methods.

Some embodiments of the present inventive concept may increase or possibly maximize reuse of expensive clinical data bay allowing mining of data using filters of original metadata, using filters of results derived during processing steps, using diagnostic conclusions or inferences recorded after processing. After mining, the resultant data pools may be processed using new methods, including methods not foreseen during the design of the original experiment. Such applications will facilitate retrospective studies applying new hypotheses and new processing methodologies and new data reduction techniques to existing data sets.

Some embodiments of the present inventive concept may facilitate collaboration among researchers using shared data sets, filters, image processing techniques, data reduction techniques, and reporting techniques. Some embodiments of the present inventive concept include local data servers and remote internet based (cloud) data servers, and the remote data servers may be single point or distributed. The interface to the processing server may be through a web services interface allowing multiple users to access data simultaneously. The system may allow multiple sites with multiple image capture devices to upload data for independent or multi-site experiments; metadata may include unique information tying data to the particular instrument from which the raw data is captured. Users may upload new methods, including image processing and data reduction methods, and such methods may be open for general use or proprietary with controlled usage rules. Further, to maintain patient confidentiality in clinical trials, patient identifying data may be encrypted with a key maintained by the particular originator of particular data sets.

Example embodiments are described above with reference to block diagrams and/or flowchart illustrations of methods, devices, systems and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, example embodiments may be implemented in hardware and/or in software (including firmware, resident software, micro-code, etc.). Furthermore, example embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Java, AJAX (Asynchronous JavaScript), C, and/or C++, for development convenience. In addition, computer program code for carrying out operations of example embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a field programmable gate array (FPGA), or a programmed digital signal processor, a programmed logic controller (PLC), or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

That which is claimed is:

1. A method for analyzing images acquired using an image acquisition system, the method comprising:
receiving a plurality of images from at least one image acquisition system;
selecting at least a portion of a set of images for analysis using at least one attribute of image metadata;
selecting at least one method for deriving quantitative information from the at least a portion of the set of images;
processing the selected at least a portion of the set of images with the selected at least one method for deriving quantitative information to generate an intermediate set of quantitative data associated with the at least a portion of the set of images; and
storing the intermediate set of quantitative data and the metadata in a reference database, the reference database including intermediate sets of quantitative data and associated metadata for images associated with a plurality of subjects.

2. The method of claim 1, wherein receiving further comprises:
receiving the plurality of images in one or more blobs of data, each blob having associated metadata; and
reconstructing the plurality of images based on the received one or more blobs and the associated metadata.

3. The method of claim 2, wherein the received blobs of data are received in one of the frequency domain and the spatial domain.

4. The method of claim 2, wherein the one or more blobs of data comprise a plurality of blobs of data in a stream of data, the method further comprising creating a branch in the stream of data to provide a first stream of raw data and a second stream of processed data.

5. The method of claim 1, wherein the at least one image acquisition system comprises at least one Optical Coherence Tomography (OCT) imaging system.

6. The method of claim 5, wherein the at least one OCT imaging system comprises at least one portable Fourier domain Optical Coherence Tomography (FDOCT) imaging System.

7. The method of claim 1, further comprising:
receiving a first multi-dimensional query at the reference database related to a subject of interest;
generating results satisfying the first multi-dimensional query;
updating the reference database based on the results satisfying the first multi-dimensional query;
refining the first multi-dimensional query based on the generated results to provide a second multi-dimensional query; and
receiving the second multi-dimensional query at the updated reference database related to the subject of interest.

8. The method of claim 7, wherein the second multi-dimensional query is configured to search only the results satisfying the first multi-dimensional query.

9. The method of claim 1, further comprising:
associating the derived quantitative information with the at least a portion of the set of images via a data structure;
selecting at least one method for aggregating at least a portion of a set of derived quantitative information into a reduced set of results; and
generating at least one report to represent the reduced set of results for one of an individual image and the set of images as a pool.

10. The method of claim 1, wherein selecting at least a portion of a set of images for analysis is preceded by:
determining specific analysis packages that are licensed on a local computer; and
dynamically populating a user interface associated with the image analysis system with controls specific to the licenses for the local computer.

11. The method of claim 1, wherein the image metadata comprises one or more of:
a patient demographic data;
an individual responsible for drawing inferences from the data;
an individual responsible for acquiring the images;
a window of time for acquiring the images;
a position in a sequence of events along which images may be acquired;
a descriptor of instruments that may be used to acquire the image data;
a descriptor of instrument settings used to acquire an image;
a descriptor of image quality associated with an image;
quantitative results derived from the image;
an inference applied to the image; and
an annotation associated with an image.

12. The method of claim 1, further comprising one of a method involving user intervention with a representation of the image displayed on graphical display; a method that is fully automated through computer algorithms without user intervention; and a method including a combination of user intervention and computer algorithms.

13. A method of transmitting image data acquired using a portable optical coherence tomography (OCT) image acquisition device, the method comprising:
continuously transmitting OCT image data during data acquisition by the portable image acquisition system, the data being transmitted as one or more blobs of data,
wherein each blob of data has associated metadata; and
wherein the metadata includes information for reconstructing the OCT image data upon receipt at a specified destination.

14. The method of claim 13, wherein one or more blobs each include kilobytes of data.

15. The method of claim 13, wherein continuously transmitting OCT image data comprises transmitting the OCT image data in the frequency domain.

16. The method of claim 15, further comprising performing a Fourier transform process on the blobs before the image data is reconstructed.

17. The method of claim 13, wherein continuously transmitting OCT image data comprises transmitting the OCT image data in the spatial domain.

18. A system for analyzing images, the system comprising:
an image acquisition system configured to acquire a plurality of images; and
an image analysis module configured to:
receive a plurality of images from at least one image acquisition system;
select at least a portion of a set of images for analysis using at least one attribute of image metadata;
select at least one method for deriving quantitative information from the at least a portion of the set of images;
process the selected at least a portion of the set of images with the selected at least one method for deriving quantitative information to generate an intermediate set of quantitative data associated with the at least a portion of the set of images; and
store the intermediate set of quantitative data and the metadata in a reference database, the reference database including intermediate sets of quantitative data and associated metadata for images associated with a plurality of subjects.

19. The system of claim 18, wherein the image analysis system is further configured to:
receive the plurality of images in one or more blobs of data, each blob having associated metadata; and
reconstruct the plurality of images based on the received one or more blobs and the associated metadata.

20. The system of claim 19, wherein the received blobs of data are received in one of the frequency domain and the spatial domain.

21. The system of claim 19, wherein the one or more blobs of data comprise a plurality of blobs of data in a stream of data, the method further comprising creating a branch in the stream of data to provide a first stream of raw data and a second stream of processed data.

22. The system of claim 18, wherein the at least one image acquisition system comprises at least one Optical Coherence Tomography (OCT) imaging system.

23. The system of claim 22, wherein the at least one OCT imaging system comprises at least one portable Fourier domain Optical Coherence Tomography (FDOCT) imaging System.

24. The system of claim 18, wherein the image analysis module is further configured to:
receive a first multi-dimensional query at the reference database related to a subject of interest;
generate results satisfying the first multi-dimensional query;
update the reference database based on the results satisfying the first multi-dimensional query;
refine the first multi-dimensional query based on the generated results to provide a second multi-dimensional query; and
receive the second multi-dimensional query at the updated reference database related to the subject of interest.

25. The system of claim 24, wherein the second multi-dimensional query is configured to search only the results satisfying the first multi-dimensional query.

26. A computer program product for analyzing images acquired using an image acquisition system, the computer program product comprising:
a non-transitory computer-readable storage medium having computer-readable program code embodied in the medium, the computer-readable program code comprising:
computer readable program code configured to receive a plurality of images from at least one image acquisition system;
computer readable program code configured to select at least a portion of a set of images for analysis using at least one attribute of image metadata;
computer readable program code configured to select at least one method for deriving quantitative information from the at least a portion of the set of images;
computer readable program code configured to process the selected at least a portion of the set of images with the selected at least one method for deriving quantitative information to generate an intermediate set of quantitative data associated with the at least a portion of the set of images; and
computer readable program code configured to store the intermediate set of quantitative data and the metadata in a reference database, the reference database including intermediate sets of quantitative data and associated metadata for images associated with a plurality of subjects.

27. A computer program product for transmitting image data acquired using a portable optical coherence tomography (OCT) image acquisition device, the computer program product comprising:
a non-transitory computer-readable storage medium having computer-readable program code embodied in the medium, the computer-readable program code comprising:
computer readable program code configured to continuously transmit OCT image data during data acquisition by the portable image acquisition system, the data being transmitted as one or more blobs of data,
wherein each blob of data has associated metadata; and
wherein the metadata includes information for reconstructing the OCT image data upon receipt at a specified destination.
